(19) United States
(12) Patent Application Publication
(10) Pub. No.: US 2016/0134670 A1
(43) Pub. Date: May 12, 2016

(54) INFORMATION PROCESSING SYSTEM, INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Kohshiro INOMATA, Kanagawa (JP)

(73) Assignee: FUJI XEROX CO., LTD., Tokyo (JP)

(21) Appl. No.: 14/722,786

(22) Filed: May 27, 2015

(30) Foreign Application Priority Data
Nov. 6, 2014 (JP) 2014-226074

(51) Int. Cl. H04L 29/06

(52) U.S. Cl. CPC H04L 65/4038; H04L 65/60

(57) ABSTRACT

A non-transitory computer readable medium stores a program causing a computer to execute a process for displaying parts of display screens in synchronization across multiple terminals connected via a network. The process includes receiving connection requests from the terminals, granting to one of the terminals having transmitted the connection request an operation right to operate on materials that are displayed in synchronization, and notifying the terminals, other than the terminal that has been granted the operation right from among the terminals having transmitted the connection requests, of material information of the materials displayed on the terminal and operation information indicating contents of an operation performed on the materials.

### CROSS-REFERENCE TO RELATED APPLICATIONS

This application is based on and claims priority under 35 USC 119 from Japanese Patent Application No. 2014-226074 filed Nov. 6, 2014.

### BACKGROUND

(i) Technical Field

The present invention relates to an information processing system, an information processing apparatus, an information processing method, and a non-transitory computer readable medium.

(ii) Related Art

Electronic conference systems are today used in meetings. In the electronic conference system, digital data, such as materials, is shared by interconnecting personal computers (PCs) and tablet terminals with each other via a network. In the electronic conference system, a terminal (hereinafter referred to as a “presenter terminal”) used by a person having a presentation right (hereinafter referred to as a “presenter”) is synchronized with terminals of participants (hereinafter referred to as “participant terminals) other than the presenter in the meeting. Display contents on a display screen of the presenter terminal (such as a display page of the material) are thus displayed on the display screens of the participant terminals.

### SUMMARY

According to an aspect of the invention, there is provided a non-transitory computer readable medium. The non-transitory computer readable medium stores a program causing a computer to execute a process for displaying parts of display screens in synchronization across multiple terminals connected via a network. The process includes receiving connection requests from the terminals, granting to one of the terminals having transmitted the connection requests an operation right to operate on materials that are displayed in synchronization, and notifying the terminals, other than the terminal that has been granted the operation right from among the terminals having transmitted the connection requests, of material information of the material displayed on the terminal and operation information indicating contents of an operation performed on the material.

### BRIEF DESCRIPTION OF THE DRAWINGS

Exemplary embodiments of the present invention will be described in detail based on the following figures, wherein:

FIG. 1 generally illustrates an electronic conference system of a first exemplary embodiment;

FIG. 2 is a block diagram illustrating the hardware configuration of a server of the first exemplary embodiment;

FIG. 3 is a functional block diagram specifically illustrating the server of the first exemplary embodiment;

FIG. 4 illustrates an example of the network configuration of an electronic conference system of the first exemplary embodiment;

FIG. 5 illustrates a table as an example of a terminal list;

FIG. 6 illustrates an operational flowchart of the electronic conference system of the first exemplary embodiment;

FIG. 7 illustrates an example of display contents displayed on a display screen of a presenter terminal;

FIG. 8 illustrates an operational flowchart of the electronic conference system of the first exemplary embodiment;

FIG. 9 illustrates an operational flowchart of the electronic conference system of the first exemplary embodiment;

FIG. 10 illustrates an operational flowchart of the electronic conference system;

FIG. 11 is a block diagram illustrating the hardware configuration of a terminal and a server of a second exemplary embodiment;

FIG. 12 is a functional block diagram specifically illustrating an electronic conference system of the second exemplary embodiment;

FIG. 13 is a functional block diagram specifically illustrating the electronic conference system of the second exemplary embodiment;

FIG. 14 illustrates an operational flowchart of the electronic conference system of the second exemplary embodiment;

FIG. 15 illustrates an example of a transmitting terminal list;

FIG. 16 illustrates an example of a receiving terminal list;

FIG. 17 illustrates an example of an updated receiving terminal list;

FIG. 18 illustrates an example of the network configuration of communication paths;

FIG. 19 illustrates an example of the network configuration of the communication paths;

FIG. 20 illustrates an example of the network configuration of the communication paths;

FIG. 21 illustrates an operational flowchart of the electronic conference system of the second exemplary embodiment;

FIG. 22 illustrates an operational flowchart of the electronic conference system of the second exemplary embodiment;

FIG. 23 illustrates an operational flowchart of the electronic conference system of the second exemplary embodiment;

FIG. 24 is a functional block diagram illustrating the specific configuration of a server of a first modification;

FIG. 25 illustrates an example of a network configuration of the electronic conference system;

FIG. 26 illustrates an example of a receiving terminal list;

FIG. 27 illustrates an example of a network configuration of communication paths of the first modification; and

FIG. 28 illustrates an example of a network configuration of the electronic conference system.

### DETAILED DESCRIPTION

Exemplary embodiments of the present invention are described below with reference to the drawings. In the exemplary embodiment, an example of an information processing system is an electronic conference system in which digital data, such as materials, and media data, such as audio data and image data, are shared among multiple terminals connected via a network.

### First Exemplary Embodiment

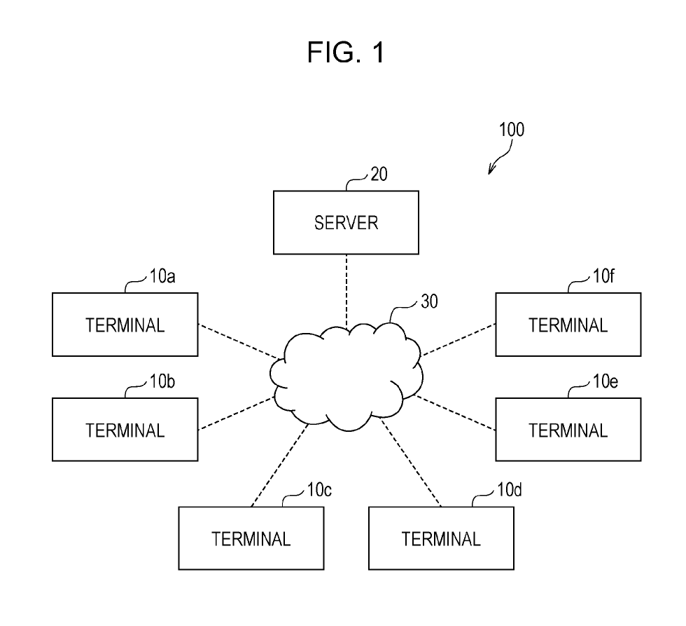

FIG. 1 generally illustrates an electronic conference system 100 of a first exemplary embodiment. The electronic conference system (information processing system) 100 includes multiple terminals 10 respectively used by multiple users participating in a meeting, and a server 20 (information processing apparatus) that manages the terminals 10. In the first exemplary embodiment, for convenience of explanation, a user who is responsible for presenting an opinion or a view in the meeting or acts as a facilitator for the meeting is referred to as a “presenter”, and a terminal used by the presenter is referred to as a “presenter terminal”. A user (other than the presenter) who participates in the meeting is referred to as a “participant”, and a terminal used by the participant is referred to as a “participant terminal”. As illustrated in FIG. 1, for example, if a terminal 10a is a presenter terminal, the other terminals 10b, 10c, 10d, 10e, and 10f are participant terminals. Each terminal may be a presenter terminal or a participant terminal. The presenter terminal is granted an operation right. In this way, a display screen responsive to contents of an operation performed on the presenter terminal by the presenter is displayed on the five other participant terminals in synchronization. Each of the terminals 10a through 10f is collectively referred to as a terminal 10 when a function common to the presenter terminal and the participant terminals is described.

Referring to FIG. 1, each of the terminals 10a through 10f is interconnected to the server 20 via a communication network 30, such as a local area network (LAN) or the Internet.

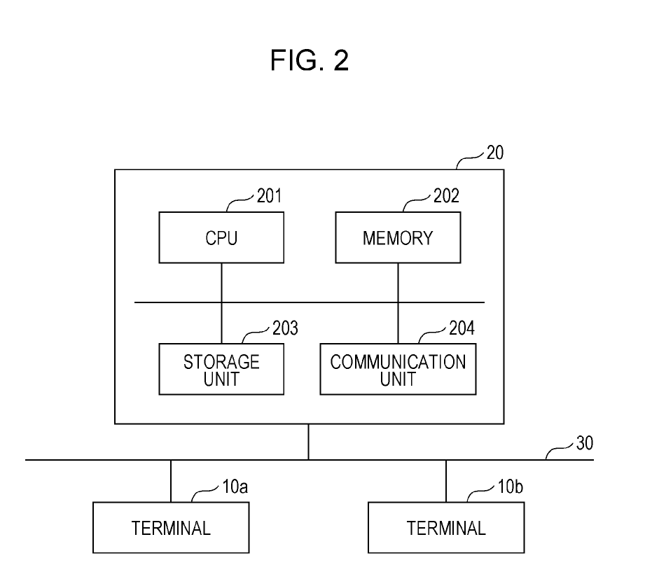

FIG. 2 is a block diagram illustrating the hardware configuration of the server 20. The server 20 is a computer including a central processing unit (CPU) 201, a memory 202, a storage unit 203, and a communication unit 204. These hardware elements are connected via a bus to transmit and receive data. The CPU 201 controls each element of the server 20 and performs a variety of information processing operations. The memory 202 stores a variety of programs and data. The memory 202 includes a working area of the CPU 201. The storage unit 203 stores data including a variety of files and documents. The communication unit 204 performs data communications with the terminal 10 via the communication network 30. The storage unit 203 may be arranged external to the server 20 and connected to the server 20 via the communication network 30.

The terminal 10 is used by a user who participates in a meeting (user terminal). The terminal 10 includes an operation unit and a display (not illustrated). The operation unit is an input device, such as a keyboard, a mouse, a pen tool, or a touchpanel. The display is a display screen on which a variety of files and documents is displayed through application software including a web browser. The display also displays an operation screen to receive an operation of a user during the meeting. The terminal 10 has software programs installed thereon, including the browser, and an electronic mail client. For example, the terminal 10 may be a mobile information terminal, such as a personal computer, a personal digital assistant (PDA), or a smart phone. The terminal 10 may be a single browser, a single window of the browser, or a single application.

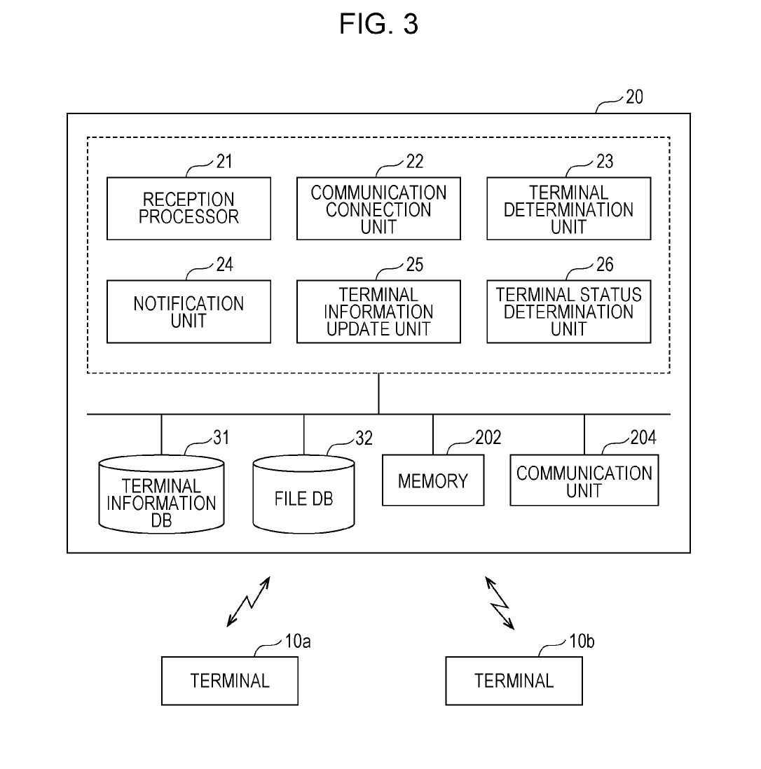

FIG. 3 is a functional block diagram specifically illustrating the server 20 of the first exemplary embodiment. The server 20 includes a reception processor 21, a communication connection unit 22, a terminal determination unit 23, a notification unit 24, a terminal information update unit 25, and a terminal status determination unit 26. These elements are implemented by the CPU 201 when the CPU 201 executes the program stored on the memory 202. The storage unit 203 includes a terminal information database (terminal information DB 31) storing terminal information and a file database (file DB 32) storing data, such as a variety of files and documents.

The program may be installed onto the server 20 from a non-transitory computer readable medium, such as a compact disk read-only memory (CD-ROM), a digital versatile disk ROM (DVD-ROM), or a memory card. The program may also be downloaded via the communication network 30, such as the Internet, or from a server that has stored the program.

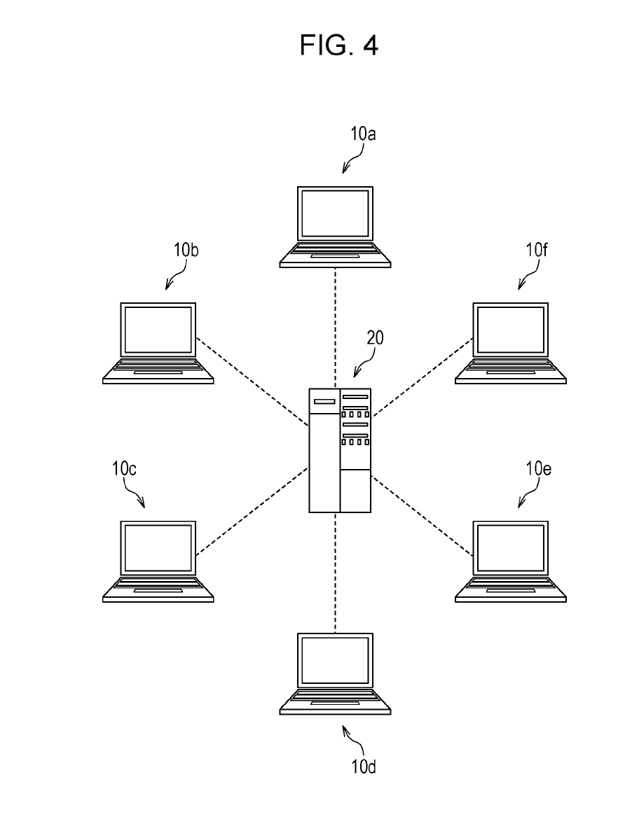

The program may be installed onto each terminal 10. As illustrated in FIG. 4, a network is constructed by interconnecting each terminal 10 to the server 20. When each terminal 10 is connected to the server 20, the program may be downloaded from the server 20 to the memory of the terminal 10, and material data for a meeting may be downloaded to the memory. The program and material data may be organized in JavaScript (registered trademark). The terminal 10 having the program downloaded thereto or recorded thereon functions as an information processing apparatus. The computer having the program downloaded thereto may be the terminal 10 or the server 20.

In the first exemplary embodiment, the server 20 stores the program that executes the functions illustrated in FIG. 3. When each terminal 10 is connected to the server 20, material data of the file DB 32 for use in a meeting and a display control program to control the display contents on the display of the terminal 10 are downloaded to each terminal 10.

The reception processor 21 receives a variety of information (operation information, request information, or the like) responsive to an operation performed on the terminal 10 by the user, and executes a process corresponding to the information. For example, the operation information may be contents of an operation performed by a presenter during a meeting (such as displaying a new material, turning pages of the material). For example, the request information may include a connection request of the terminal 10 to the server 20, a cutoff request, or a presenter change request (transfer request of the operation right). The reception processor 21 has a function of a receiving unit to receive a connection request from the terminal 10 and a transfer request receiving unit to receive the transfer request of the operation right from the terminal 10.

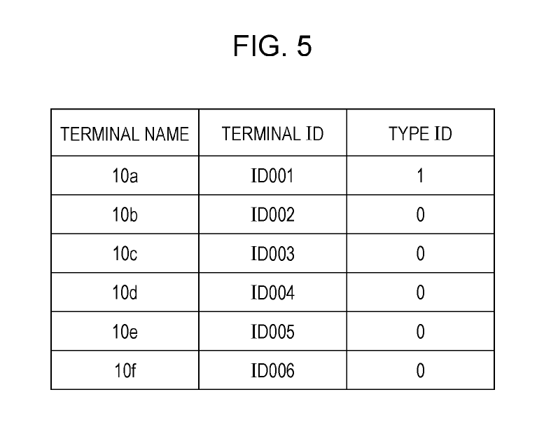

Upon receiving the connection request from the terminal 10, the reception processor 21 registers the terminal information of the terminal 10 in a terminal list of the terminal information DB 31. The terminal information includes identification information (terminal ID) of the terminal 10 and type information (type ID) indicating whether the terminal 10 is a presenter terminal or a participant terminal. FIG. 5 illustrates a table as an example of the terminal list. As illustrated in FIG. 5, “1” represents a presenter terminal while “0” represents a participant terminal. The user using the terminal 10a is a presenter, and the users who respectively use the terminals 10b, 10c, 10d, 10e, and 10f are participants of the meeting.

In response to a connection request or a cutoff request from the terminal 10, the communication connection unit 22 establishes or cuts off communications with the terminal 10. Communication standards the electronic conference system 100 complies with are not limited to any particular standards, but may be WebSocket, for example.

The terminal determination unit 23 references the terminal list (FIG. 5) of the terminal information DB 31 to determine whether the terminal 10 has been registered as a presenter terminal or a participant terminal.

The notification unit 24 notifies the terminal 10 of a variety of messages including a query message. In response to the received message, the terminal 10 causes the display to display the message. For example, the contents of the messages may include a query asking whether a user wants to present a user's view during a meeting (obtain an operation right), such as “do you want to present your view?”, or a query asking the presenter whether he or she permits himself or herself to change to another presenter during the meeting (he or she transfers the operation right to another presenter), such as “do you permit yourself to change to another presenter?), or a notification that there is no presenter in the meeting “there is no presenter having the operation right”. The notification unit 24 has a function of a querying unit.

The notification unit 24 notifies each participant terminal of the operation information of the presenter (presenter operation information) at the beginning of and during the meeting. For example, the presenter operation information indicates displaying a new material, writing to the material using a pen tool (writing tool), picking (selecting) a posted comment, page turning of the material, and inputting and moving a mouse pointer. For example, when the presenter operation information (such as information of a material ID and page number when the presenter turn pages of the material) is received from the presenter terminal, the notification unit 24 notifies the participant terminals of the presenter operation information. The notification unit 24 also has a function of an operation information notification unit to notify of the operation information. Upon receiving the presenter operation information from the notification unit 24, the participant terminal reads the material data corresponding to the material ID and page number from the memory thereof, and then displays the material data on the display screen thereof. The participant terminal executes the display control program, thereby causing the display thereof to display the display contents corresponding to the presenter operation information. The terminal 10 functions as a display controller.

The terminal information update unit 25 updates the terminal list (FIG. 5) of the terminal information DB 31 in accordance with the contents of the operation of the user of the terminal 10. For example, if one presenter (operation right) changes to another during the meeting, the terminal information update unit 25 updates the type IDs representing the presenter terminal and the participant terminals. The terminal information update unit 25 also adds the terminal information of a terminal 10 newly connected as a participant terminal during the meeting.

The terminal status determination unit 26 determines the current status of the terminal 10 during the meeting. For example, the terminal status determination unit 26 determines a period of time throughout which the presenter operation information is not transmitted from the presenter terminal 10, and a period of time from when a query message is transmitted to when the presenter terminal 10 replies to the query.

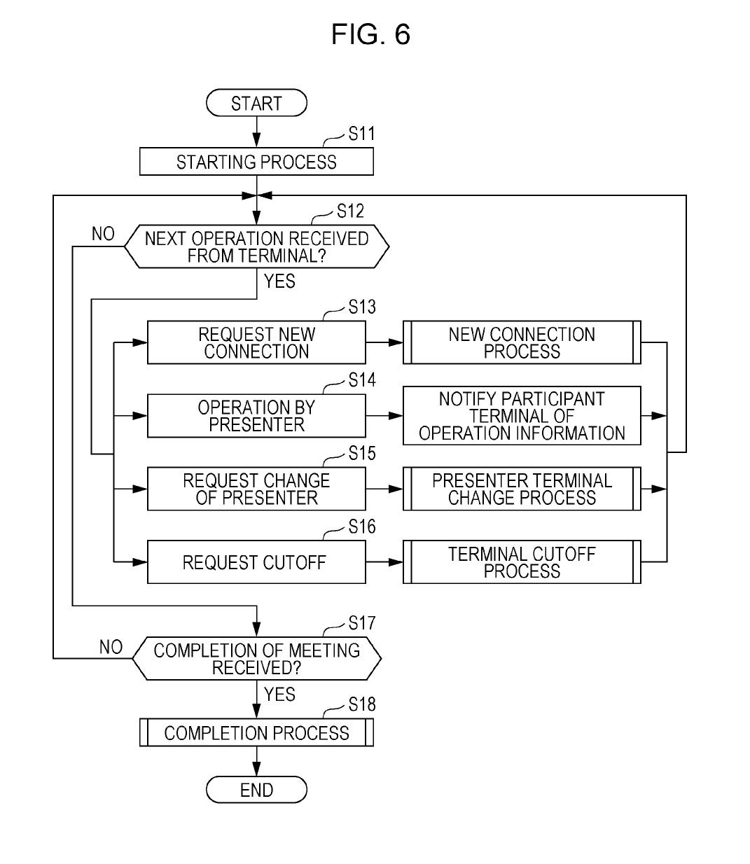

The flow of the process of the electronic conference system 100 is described below. FIG. 6 illustrates an operational flowchart of the server 20 in the electronic conference system 100. FIG. 6 diagrammatically illustrates the general flow of the process from the beginning to the end of the meeting.

The electronic conference system 100 starts the process by executing the program stored on the server 20 (S11). When the reception processor 21 in the server 20 receives a variety of operations from the terminals 10 (including the presenter terminal and the participant terminals) (S12), each element in the server 20 performs an operation responsive to the received contents of the operation.

In step S12, the reception processor 21 in the server 20 receives a connection request from the terminal 10. The server 20 executes a “new connection process” (step S13). The new connection process is performed at the beginning of or during the meeting.

When the reception processor 21 receives the presenter operation information in step S12, the notification unit 24 notifies the participant terminals of the presenter operation information (step S14). In the new connection process, the terminal 10a may now selected as the presenter terminal (granted the operation right), and the terminals 10b, 10c, 10d, 10e, and 10f may become the participant terminals.

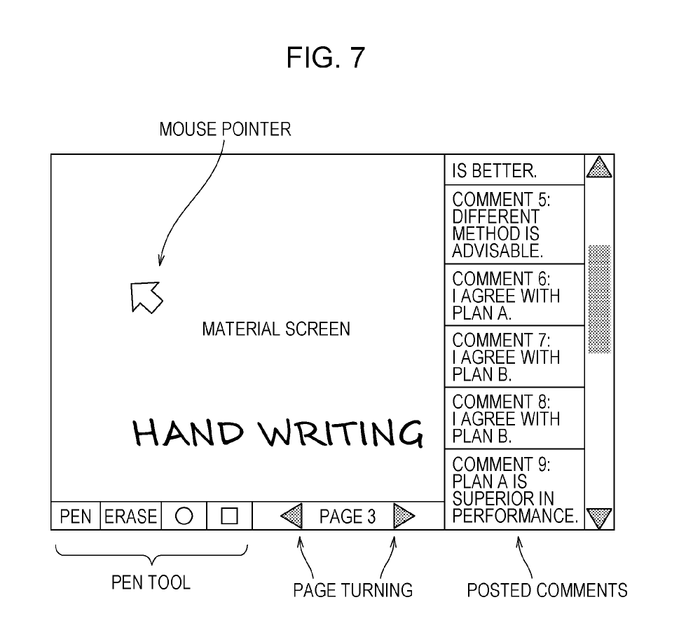

The reception processor 21 may receive information indicating the contents of operations, such as displaying a new material, writing to the material using a pen tool (writing tool), picking (selecting) a posted comment, page turning of the material, and inputting and moving a mouse pointer. The process of the terminal 10a is specifically described. FIG. 7 illustrates an example of display contents displayed on a display screen of the presenter terminal 10a. For example, the presenter may now operate a mouse or the like on the terminal 10a to read the material stored on the memory thereof (an operation to display a new material on a material screen). The reception processor 21 may then receive from the presenter terminal 10a the presenter operation information including the material ID and page number. Also, for example, the presenter may now operate the mouse on the presenter terminal 10a to enter a mouse pointer on the material screen (see FIG. 7) displayed on the display. The reception processor 21 may then receives from the presenter terminal 10a the presenter operation information including the position of the mouse pointer (coordinates), and the input material ID and page number. Also, the presenter may now operate the pen tool on the presenter terminal 10a to write characters or the like on the material screen (see FIG. 7) displayed on the display. The reception processor 21 may then receive from the presenter terminal 10a the presenter operation information including the written position (coordinates), and the written material ID and page number. Also, for example, the presenter may operate the mouse on the presenter terminal 10a to turn pages on the material screen (see FIG. 7) displayed on the display. The reception processor 21 may then receive from the presenter terminal 10a the presenter operation information including the displayed material ID and specified page number. The methods for synchronous display and asynchronous display may be those of related art.

When the reception processor 21 receives the presenter operation information, the notification unit 24 notifies each of the participant terminals 10b, 10c, 10d, 10e, and 10f of the presenter operation information. Upon receiving the presenter operation information, each of the participant terminals 10b, 10c, 10d, 10e, and 10f displays a display screen corresponding to the presenter operation information. For example, each of the participant terminals 10b, 10c, 10d, 10e, and 10f reads from the memory thereof the material data corresponding to the material ID and page number, and displays the material data on the display screen thereof. The electronic conference system 100 returns to step S12 after receiving the presenter operation information from the presenter terminal 10a, notifying each of the participant terminals 10b, 10c, 10d, 10e, and 10f of the presenter operation information, and performing synchronous displaying. The reception processor 21 then receives a variety of operations from each terminal 10 again.

If the reception processor 21 receives a presenter change request from the participant terminal 10b in step S12, the electronic conference system 100 performs a “presenter terminal change process” (step S15) to be discussed later.

If the reception processor 21 receives a cutoff request from the terminal 10 in step S12, the electronic conference system 100 performs a “terminal cutoff process” (step S16) to be discussed later. More specifically, the reception processor 21 receives the cutoff request from the presenter terminal 10a or the cutoff request from the participant terminal 10b during the meeting.

Upon receiving an instruction to end the meeting from the terminal 10 (step S17), the reception processor 21 performs a meeting ending process to end the meeting (step S18). If the reception processor 21 receives an instruction to end the meeting from the presenter terminal 10a granted the operation right, the notification unit 24 notifies all the participant terminals of a message of the end of the meeting, and the communication connection unit 22 cuts off the network connection with all the terminals 10. If no instruction to end the meeting has been received, the reception processor 21 returns to step S12 to receive a variety of operations from each terminal 10.

When each of the “new connection process”, the “presenter terminal change process”, and the “terminal cutoff process” is complete, processing returns to step S12 and the reception processor 21 receives a variety of operations from each terminal 10.

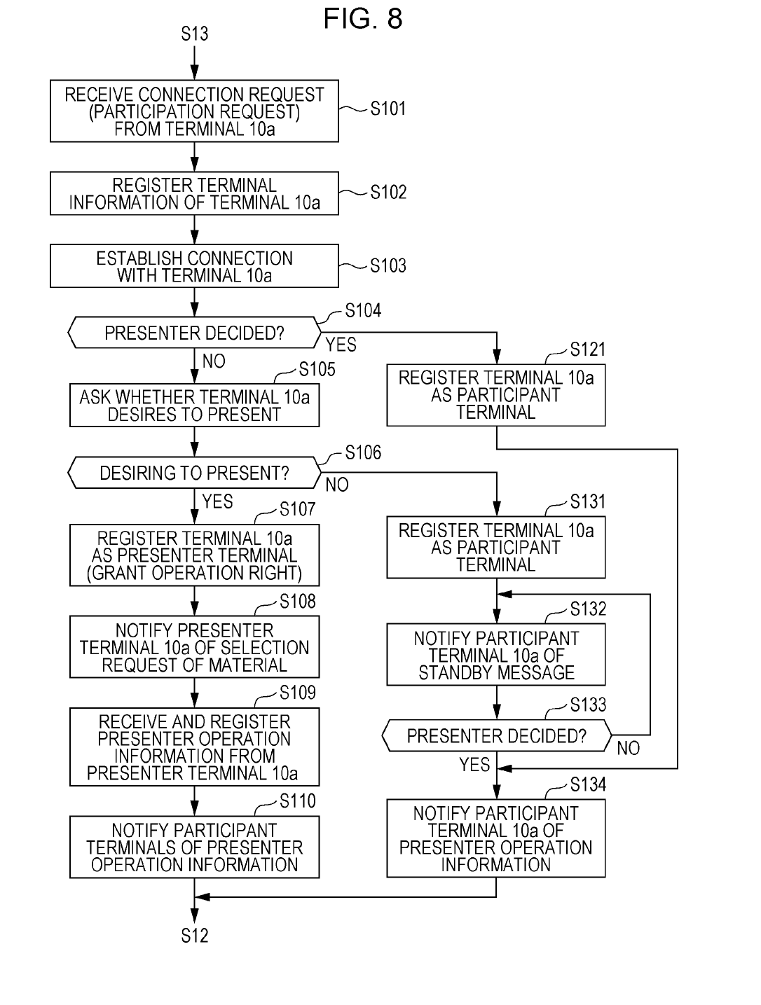

The flow of the “new connection process” is described below. FIG. 8 illustrates an operational flowchart of the “new connection process” of the electronic conference system 100.

The reception processor 21 in the server 20 receives a connection request from the terminal 10a (step S101). Upon receiving the connection request, the reception processor 21 registers the terminal information of the terminal 10a in the terminal list (see FIG. 5) of the terminal information DB 31 (step S102). The communication connection unit 22 establishes a communication connection between the server 20 and the terminal 10a (step S103).

The terminal determination unit 23 references the terminal list of the terminal information DB 31 and determines whether a presenter is decided, in other words, the terminal 10 granted the operation right is already determined (step S104). More specifically, the terminal determination unit 23 determines whether “1” representing a presenter terminal is registered in the terminal list.

If no presenter is decided yet (no branch from step S104), the notification unit 24 asks the terminal 10a whether the user of the terminal 10a desires to present his or her view (obtain the operation right) (step S105). Upon receiving from the terminal 10a a reply that the user desires to present a view (yes branch from step S106), the reception processor 21 registers “1” in the type ID column of the terminal 10a in the terminal list (step S107). More specifically, the reception processor 21 grants the terminal 10a the operation right. The reception processor 21 has a function of a right granting unit to grant the terminal 10 the operation right. The terminal 10a is then registered as the presenter terminal. The notification unit 24 requests the presenter terminal 10a to select the material for use in the presentation (step S108). Upon receiving a reply responsive to the selection request (the presenter operation information), the reception processor 21 registers the received presenter operation information (step S109). The notification unit 24 notifies all the participant terminals registered in the terminal list of the presenter operation information (S110). Processing then returns to step S12. The notification unit 24 has a function of a selection request transmitting unit to transmit a selection request of a new material shared in the meeting.

Upon receiving from the terminal 10a a reply that the user does not desire to present a view (no branch from step S106), the reception processor 21 registers “0” in the type ID column of the terminal 10a in the terminal list. In this way, the terminal 10a is registered as a participant terminal. In such a case, no presenter is yet decided, and the reception processor 21 has not yet received the presenter operation information. The notification unit 24 notifies the presenter terminal 10a of a standby message. For example, the standby message may be “wait until a presenter is decided”. The standby message (standby screen) is displayed on the display screen of the presenter terminal 10a. Throughout this period, the presenter terminal 10a is in an asynchronous state, and may display a desired screen responsive to an operation of the user. If a presenter is decided (yes branch from step S133), the notification unit 24 notifies the presenter terminal 10a of the presenter operation information received by the reception processor 21 (step S134). Processing returns to step S12. The standby message remains displayed on the display screen of the presenter terminal 10a until a presenter is decided (no branch from step S133).

If a presenter is already decided in step S104 (yes branch from step S104), the reception processor 21 registers “0” in the type ID column of the terminal 10a in the terminal list. In this way, the terminal 10a is registered as a participant terminal. If a presenter is already decided, the reception processor 21 has already received the presenter operation information from the presenter terminal 10. For this reason, the notification unit 24 immediately notifies the terminal 10a already registered as a participant terminal of the presenter operation information (step S134). Processing returns to step S12.

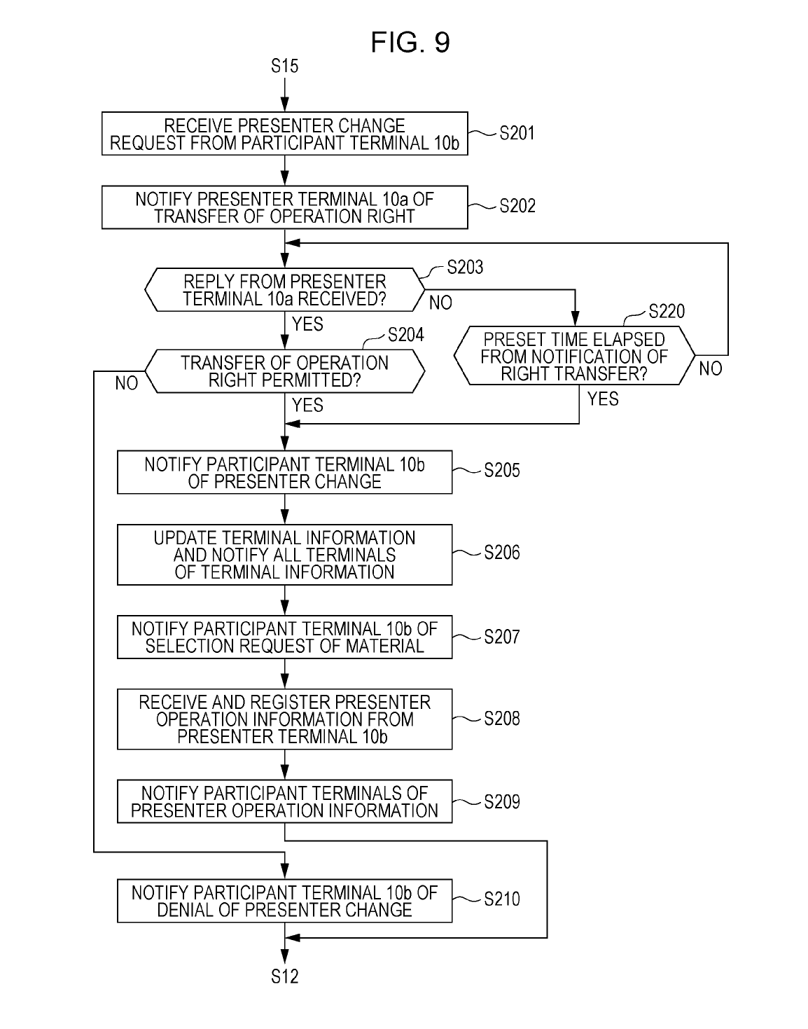

The flow of the “presenter terminal change process” is described below. FIG. 9 illustrates an operational flowchart of the “presenter terminal change process” of the electronic conference system 100. In this case, the terminal 10a is registered as a presenter terminal.

The reception processor 21 in the server 20 receives a presenter change request (transfer request of the operation right) from the terminal 10b (step S201). The notification unit 24 asks the terminal 10a whether the change of the presenter is to be permitted (step S202). More specifically, the notification unit 24 notifies the terminal 10a of the transfer request of the operation right.

The terminal status determination unit 26 determines whether the reception processor 21 has received a reply from the terminal 10a (step S203). If the reception processor 21 has received the reply, processing proceeds to step S204. If the reception processor 21 has not received the reply, processing proceeds to step S220. In step S220, the terminal status determination unit 26 determines whether a predetermined set time has elapsed since the notification of the transfer of the operation right to the presenter terminal 10a (step S220). If the reply is received prior to the time elapse of the predetermined set time, processing returns to step S203. If the predetermined set time has elapsed, processing proceeds to step S205.

In step S204, the reception processor 21 determines whether the reply received from the presenter terminal 10a is “to permit” (yes branch from step S204), more specifically, the user of the terminal 10a has agreed that he or she changes another user as a presenter (transfers the operation right to another user), the notification unit 24 notifies the participant terminal 10b having made the presenter change request of a message to that effect (step S205). The reception processor 21 (right granting unit) modifies the type ID column of the terminals 10a and 10b in the terminal list. The notification unit 24 notifies the other terminals 10 of a message that the user of the terminal 10a is replaced with the user of the terminal 10b as a presenter (step S206). More specifically, the reception processor 21 updates the type ID of the terminal 10a from “1” to “0” and the type Id of the terminal 10b from “0” to “1”. The reception processor 21 transfers the operation right from the terminal 10a to the terminal 10b. In this way, the terminal 10a is changed to be a participant terminal, and the terminal 10b is changed to a presenter terminal.

The notification unit 24 requests the terminal 10b to select a material for use in presentation (step S207). Upon receiving a reply to the selection request (the presenter operation information), the reception processor 21 registers the received presenter operation information (step S208). The notification unit 24 notifies all the participant terminals registered in the terminal list of the presenter operation information (step S209). Processing returns to step S12.

If the reply received by the reception processor 21 from the terminal 10a in step S204 is “to deny” (no branch from step S204), the notification unit 24 notifies the presenter terminal 10b of a message saying that the presenter change request is denied (step S210). Processing returns to step S12. Through the above process, the presenter changes (the operation right is transferred) during the meeting.

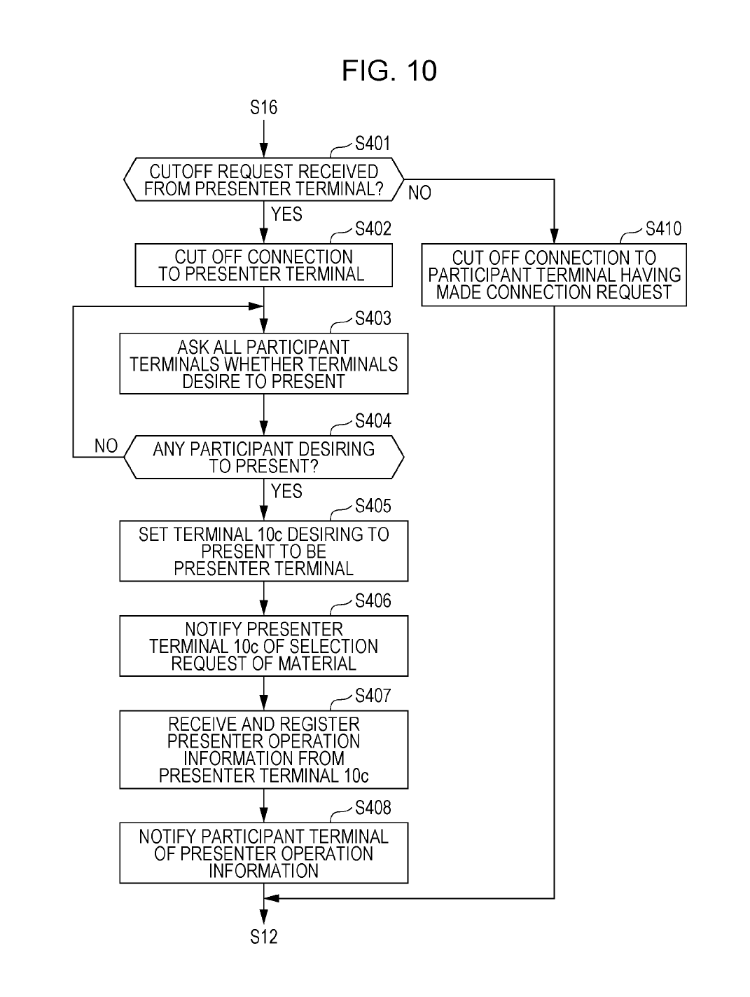

The flow of the “terminal cutoff process” is described below. FIG. 10 illustrates an operational flowchart of the “terminal cutoff process” of the electronic conference system 100.

If the reception processor 21 in the server 20 receives a cutoff request from the terminal 10 during the meeting, the terminal determination unit 23 determines whether the terminal 10 having made the cutoff request is the presenter terminal, in other words, whether the terminal 10 is granted the operation right (step S401). The cutoff request is typically made when a user who has participated in the meeting leaves the meeting for some reason.

If the cutoff request has been received from the presenter terminal (yes branch from step S401), the communication connection unit 22 cuts off the communications with the presenter terminal (step S402). In this case, there is neither presenter terminal nor presenter. The notification unit 24 first asks all the (participant) terminals 10 whether each of the terminals 10 desires to present a view in the meeting (step S403). Alternatively, the notification unit 24 may notify all the terminals 10 of a message saying that there is no terminal having (granted) the operation right. For example, upon receiving from the terminal 10c a reply that the terminal 10c desires to present (yes branch from step S404), the reception processor 21 updates the type ID column for the terminal 10c in the terminal list from “0” to “1” (step S405). More specifically, the reception processor 21 transfers the operation right to the terminal 10c. The terminal 10c is thus registered as a presenter terminal. The notification unit 24 requests the terminal 10c that the terminal 10c select a material for use in the presentation (step S406). Upon receiving a reply (the presenter operation information) responsive to the selection request, the reception processor 21 registers the received presenter operation information (step S407). The notification unit 24 notifies all the participant terminals registered in the terminal list of the presenter operation information (step S408). Processing returns to step S12.

If the reception processor 21 receives the cutoff request from a participant terminal in step S401 (no branch from step S401), the communication connection unit 22 cuts off the communications with the participant terminal (step S410). Processing returns to step S12. Through the above process, the cutoff process with the terminal is performed during the meeting.

The electronic conference system 100 of the first exemplary embodiment is not limited to the above configuration. For example, if a predetermined period of time may elapse with the network connection of the presenter terminal 10 cut off because of a system failure, operations in steps S403 through S408 of FIG. 10 may be performed. Multiple users (presenter candidates) desiring to present may be registered in advance in the electronic conference system 100. In such a case, if one presenter terminal 10 is cut off, the other terminals 10 may be asked in candidate order whether each terminal 10 desires to present (such as in the operation in step S105 of FIG. 8). In the electronic conference system 100, a participant X may transmit to the other participant terminals a message that the participant X desires to present during the meeting, and may force-replace the presenter (force-transfers the operation right to the terminal 10 of the participant X) under majority rule in response to the replies from the other participant terminals.

### Second Exemplary Embodiment

An electronic conference system 200 of a second exemplary embodiment is described. The discussion of elements and functions similar to those of the electronic conference system 100 of the first exemplary embodiment is omitted as appropriate.

The electronic conference system 200 (information processing system) of the second exemplary embodiment is similar in function to the electronic conference system 100 of the first exemplary embodiment (see FIG. 3). The electronic conference system 200 further includes a function of controlling communications of the media data including audio data and image data regardless of a shared state (synchronous or asynchronous display) of the materials (display contents). For example, the electronic conference system 200 helps hold a meeting efficiently regardless of whether a user (presenter) who operates on contents displayed on the display screen during a meeting is the same user as or different from the user (speaker) who speaks his or her view.

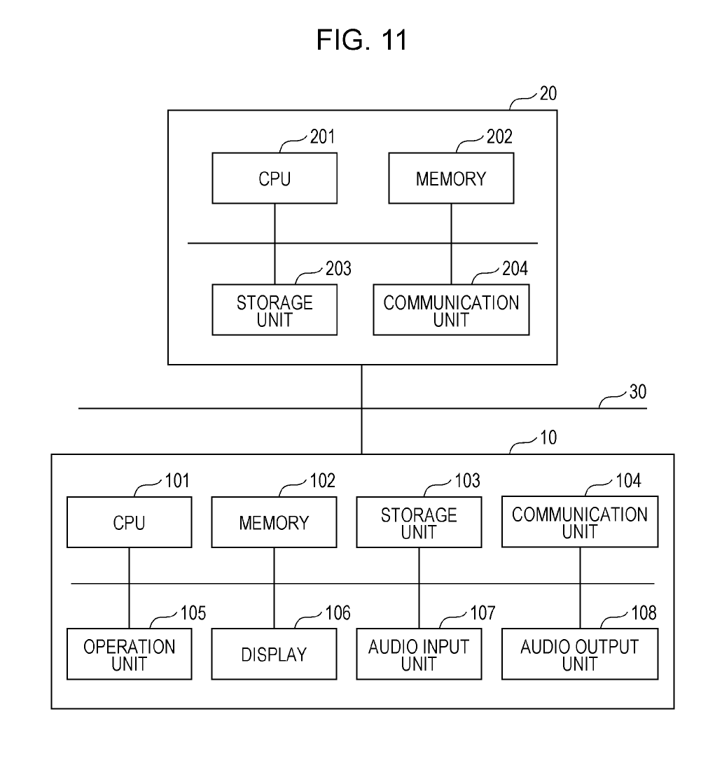

FIG. 11 is a block diagram illustrating the hardware configuration of the terminal 10 and the server 20 of the second exemplary embodiment. The terminal 10 includes a computer including a CPU 101, a memory 102, a storage unit 103, a communication unit 104, an operation unit 105, a display 106, an audio input unit 107, and an audio output unit 108. These hardware elements are interconnected to each other via a bus to exchange data. The CPU 101 controls each element of the terminal 10, and performs a variety of information processing operations. The memory 102 stores a variety of programs and data. The memory 102 also includes a working area used by the CPU 101. The storage unit 103 stores data including a variety of files and documents. The communication unit 104 performs data communications with the server 20 and the other terminals 10 via the communication network 30. The operation unit 105 is an input device, such as a keyboard, a mouse, a pen tool, a touchpanel or the like. The display 106 is a display screen that displays a variety of files and documents through an application software program, such as a web browser. The display 106 displays the operation screen that receives an operation performed by the user during the meeting and a material used during the meeting. The audio input unit 107 is a microphone that picks up a user's voice spoken during the meeting. The audio output unit 108 is a loudspeaker that outputs audio data received from another terminal 10 as an audio output. Optionally, the storage unit 103, the operation unit 105, the display 106, the audio input unit 107, and the audio output unit 108 may be arranged to be external to the terminal 10, and connected to the terminal 10 via the communication network 30.

The terminal 10 may include a transmission function to transmit the audio data of a voice spoken by a user and/or a reception function to receive the audio data. The functions of each terminal 10 may be decided in response to an instruction of the user who uses each terminal 10 or the proceedings of the meeting.

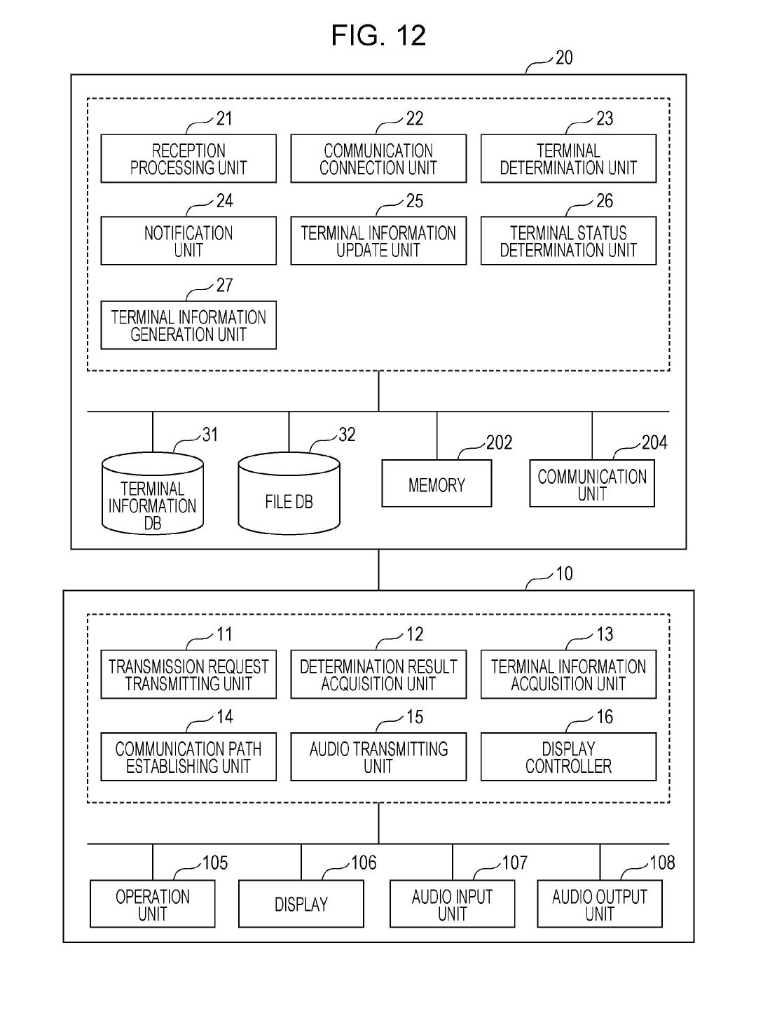

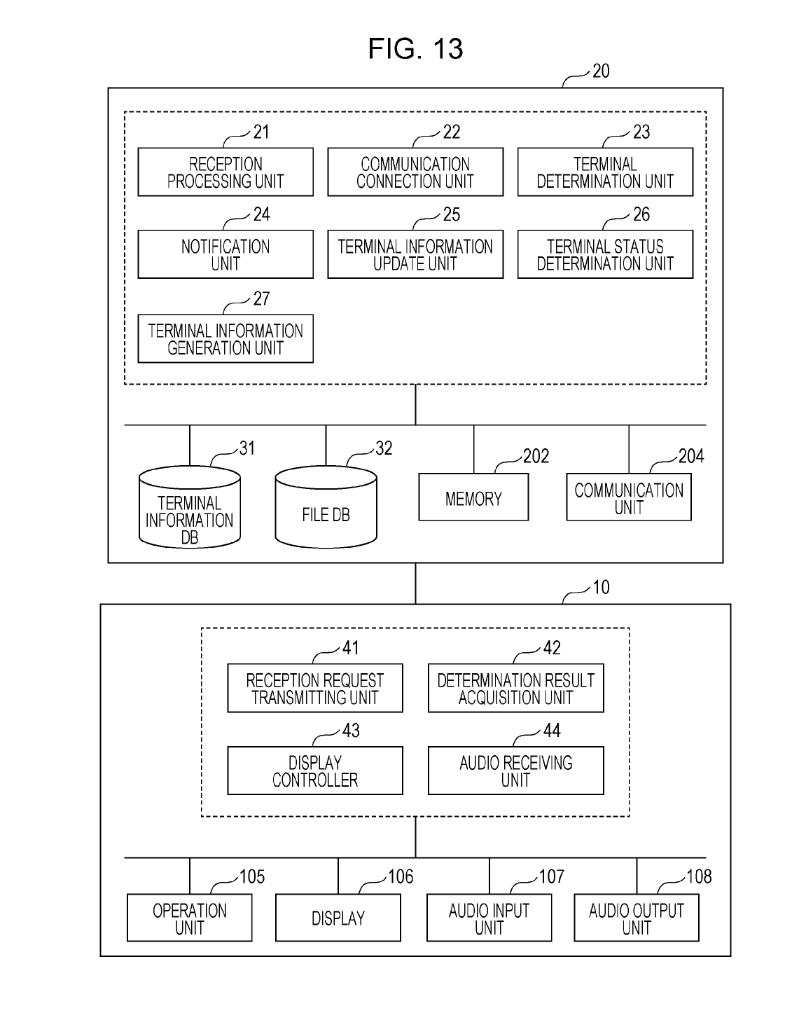

FIG. 12 and FIG. 13 are functional block diagrams specifically illustrating the electronic conference system 200. For convenience of explanation, the terminal 10 of FIG. 12 (also referred to as a transmitting terminal) includes functional blocks for the transmission function and the terminal 10 of FIG. 13 (hereinafter referred to as a receiving terminal) includes functional blocks for the reception function. As described above, the transmitting terminal 10 may further include the reception function (see FIG. 13), and the receiving terminal 10 may further include the transmission function (see FIG. 12). Each terminal having both the reception function and the transmission function may also be described as appropriate. Any of the transmitting terminal 10 and the receiving terminal 10 may have the operation right, or none of both may have the operation right.

Referring to FIG. 12 and FIG. 13, the server 20 includes a terminal information generation unit 27 in addition to the configuration of the electronic conference system 100 (see FIG. 3) of the first exemplary embodiment. As illustrated in FIG. 12, the transmitting terminal 10 includes a transmission request transmitting unit 11, a determination result acquisition unit 12, a terminal information acquisition unit 13, a communication path establishing unit 14, an audio transmitting unit 15, and a display controller 16. As illustrated in FIG. 13, the receiving terminal 10 includes a reception request transmitting unit 41, a determination result acquisition unit 42, a display controller 43, and an audio receiving unit 44.

The elements included in the terminal 10 and the elements included in the server 20 may be respectively implemented by the CPU 101 and the CPU 201 when the CPU 101 and the CPU 201 execute the programs respectively stored on the memory 102 and the memory 202 (see FIG. 11).

The programs may be installed onto the terminal 10 and the server 20 from a non-transitory computer readable information storage medium, such as a CD-ROM, DVD-ROM, memory card or the like. The programs may be downloaded via the communication network 30, such as the Internet. The programs corresponding to the elements may be pre-stored on the server 20 and then downloaded to the terminals 10.

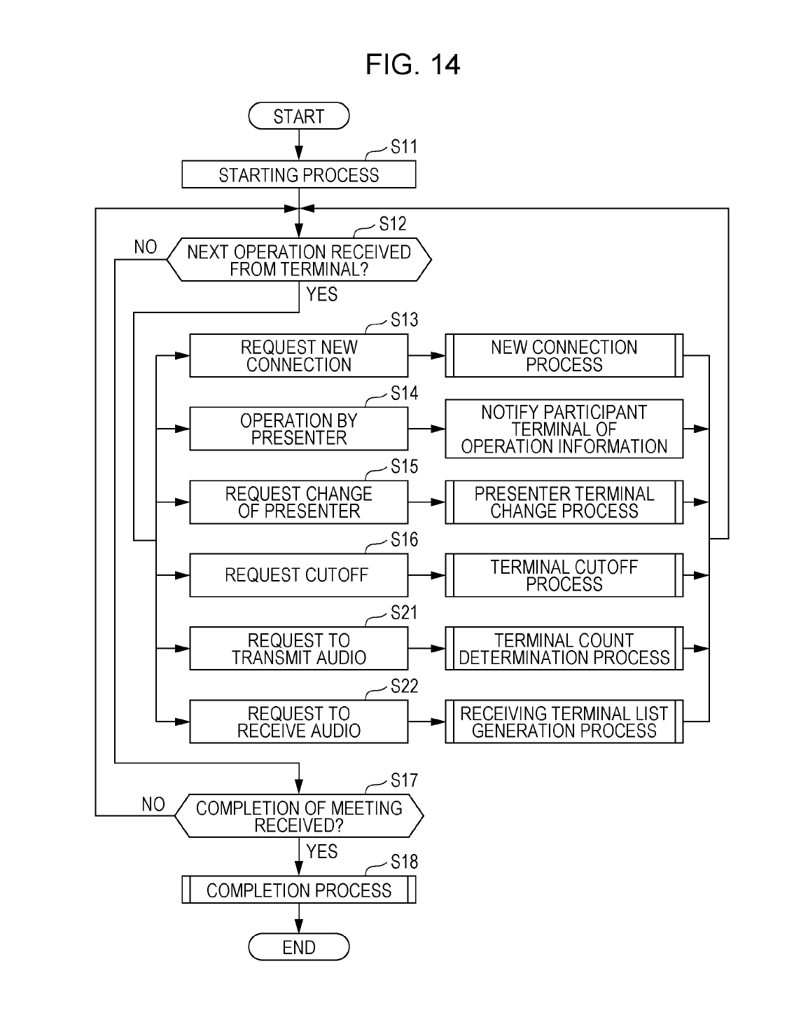

The operational flow of the electronic conference system 200 is described below. FIG. 14 illustrates an operational flowchart of the server 20 of the electronic conference system 200. FIG. 14 illustrates general proceedings of a meeting from the beginning to the end of the meeting.

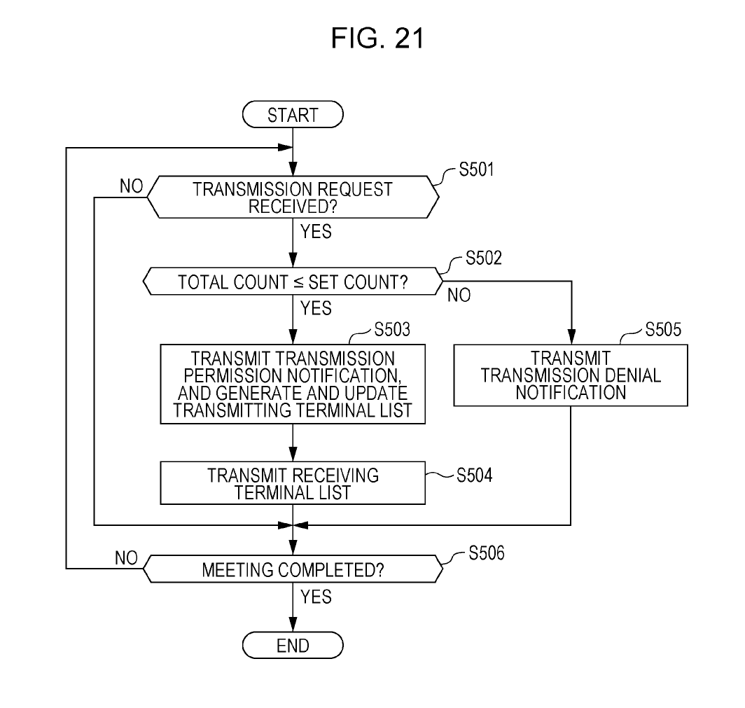

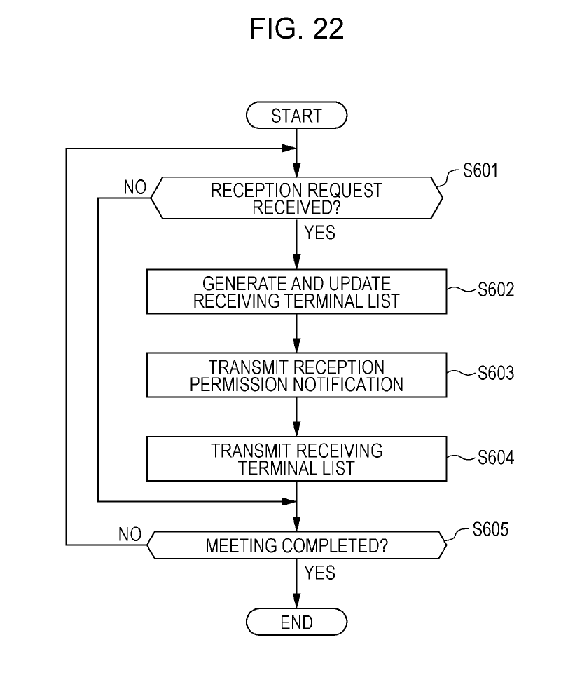

If the reception processor 21 in the server 20 receives a connection request from the terminal 10 (step S13), the server 20 performs the “new connection process” (see FIG. 8) of the first exemplary embodiment. If the reception processor 21 receives the presenter operation information from the presenter terminal (step S14), the notification unit 24 notifies the participant terminal of the presenter operation information (synchronous displaying process). If the reception processor 21 receives the presenter change request from the participant terminal 10 (step S15), the server 20 performs the “presenter terminal change process” (see FIG. 9) of the first exemplary embodiment. If the reception processor 21 receives the cutoff request from the terminal 10 (step S16), the server 20 performs the “terminal cutoff process” (see FIG. 10) of the first exemplary embodiment. If the reception processor 21 receives an audio transmission request (hereinafter referred to as a transmission request) (step S21), the server 20 performs a process of FIG. 21 (“terminal count determination process”. If the reception processor 21 receives an audio reception request (hereinafter referred to as a reception request) (step S22), the server 20 performs a process of FIG. 22 (“receiving terminal list generation process”). The reception processor 21 has a function of a transmission request receiving unit to receive the transmission request, and a function of a reception request receiving unit to receive the reception request.

The following discussion focuses on the function of the electronic conference system 200 to perform audio communications.

The transmission request is transmitted from the terminal 10 to the server 20 in response to an operation of the user. More specifically, the user may wish to transmit his or her own statement (voice) to another terminal 10. More specifically, the user may request a communication path to be established to transmit audio data from the user's own terminal and another terminal. The user then operates the operation unit 105 in the terminal 10 to enter an instruction to establish the communication path. For example, a user A may use a keyboard or mouse to select a checkbox or an electronic button on a selection screen of the “audio transmission” displayed on the display 106 in the terminal 10 (see FIG. 12) used by himself or herself. The transmission request transmitting unit 11 in the terminal 10 transmits the request received from the user A (hereinafter referred to as a transmission request) to the server 20. If the user A sets the checkbox of the audio transmission unchecked or a predetermined condition is satisfied (as described below), the transmission request transmitting unit 11 transmits a cancel request of transmission. For example, the transmission request transmitting unit 11 transmits “+1” to transmit the transmission request, or transmits “−1” to transmit the cancel request.

The reception request is transmitted from the terminal 10 to the server 20 in response to an operation of the user. Specifically, a user may wish to receive the statement (voice) of another user, and operate the operation unit 105 in the terminal 10 to enter an instruction to that effect. For example, a user B may use a keyboard or mouse to select a checkbox or an electronic button on a selection screen of the “audio reception” displayed on the display 106 in the terminal 10 (see FIG. 13) used by himself or herself. The reception request transmitting unit 41 in the terminal 10 transmits the request received from the user B (hereinafter referred to as a reception request) to the server 20. If the user B sets the checkbox of the audio reception unchecked or a predetermined condition is satisfied (as described below), the reception request transmitting unit 41 transmits a cancel request of reception. For example, the reception request transmitting unit 41 transmits “+1” to transmit the reception request, or transmits “−1” to transmit the cancel request.

Each terminal 10 displays the selection screens, one for the “audio transmission” and the other for the “audio reception”, and each user individually selects the selection screen. For example, the user A may select both the “audio transmission” and the “audio reception” on the terminal 10.

The reception processor 21 (a transmission request receiving unit) in the server 20 receives the transmission request transmitted from the transmission request transmitting unit 11 in the terminal 10. If the transmission request is transmitted from each of the terminals 10a and 10f, the reception processor 21 receives the transmission request from each of the terminals 10a and 10f.

The reception processor 21 (a reception request receiving unit) in the server 20 receives the reception request transmitted from the reception request transmitting unit 41 in the terminal 10. If the reception request is transmitted from each of the terminals 10a through 10f, the reception processor 21 receives the reception request from each of the terminals 10a through 10f.

The terminal determination unit 23 in the server 20 responds to the transmission request received by the reception processor 21 to determine whether to permit the terminal 10 having transmitted the transmission request to perform the audio transmission. More specifically, the terminal determination unit 23 compares the total number of terminals having made the transmission request received by the reception processor 21 with a predetermined set number of terminals to determine whether the total number is equal to or below the predetermined set number. If the total number is equal to or below the set number, the terminal determination unit 23 permits the terminal having made the transmission request to transmit the audio. If the total number is above the set number, the terminal determination unit 23 denies the audio transmission. For example, the set number may be “3”, and the terminals 10a and 10f may make the transmission request. Since the total number (two terminals) is less than the set number (three terminals), the terminal determination unit 23 permits the terminals 10a and 10f to transmit the audio.

The terminal determination unit 23 calculates the total number of terminals 10 having made the transmission requests at the present time (at the time point the terminal as a determination target makes the transmission request). For example, the terminals 10a and 10f have already made the transmission request, followed by the terminal 10b. At the present time, the total number of terminals is 3. If the set number of terminals is “2”, the terminals 10a and 10f have already made the transmission request (the audio transmission may have been performed), and the terminal 10b has now made the transmission request. Since the total number of terminals (3) is above the set number (2), the terminal determination unit 23 denies the audio transmission by the terminal 10b which has newly made the transmission request.

The audio transmission is permitted until the number of terminals having made the transmission request reaches the set number of terminals. If the number of terminals 10 permitted to perform the audio transmission reaches the set number, and the audio transmission (communication path) is canceled for any one terminal 10, another terminal 10 is permitted to perform the audio transmission.

The terminal determination unit 23 transmits determination results (permission notification or denial notification) to the terminal 10 that has transmitted the transmission request.

In response to the reception request received by the reception processor 21, the terminal determination unit 23 determines whether to permit the terminal 10 having transmitted the reception request to perform the audio reception. More specifically, the terminal determination unit 23 compares the total number of terminals 10 having made the reception request received by the reception processor 21 with a predetermined set number to determine whether the total number is equal to or below the set number. The terminal determination unit 23 may also determine whether to permit the reception request to be performed based on another condition described below (as described a modification 1). The terminal determination unit 23 may also permit all the reception requests received by the reception processor 21 to be performed. The terminal determination unit 23 then transmits the determination results (permission notification or denial notification) to the terminal 10 having transmitted the reception request.

If the total number of terminals 10 permitted to make the transmission request reaches a specified value (the set number), the terminal determination unit 23 may transmit to all the terminals 10 connected to the server 20 a notification (message) that the number of transmitting terminals has reached the set number of terminals, and that no more transmission request is permitted. Similarly, if the total number of terminals permitted to make the transmission request become lower than the set number after the reception of a transmission cancellation request, the terminal determination unit 23 may transmit to all the terminals 10 a notification that a new transmission request becomes permissible. The terminal determination unit 23 may transmits to all the terminals 10 a notification indicating the remaining number of terminals before the set number is reached. For example, if the set number is 2, the terminal determination unit 23 transmits a transmission permission to the terminal 10a in response to the transmission request made by the terminal 10a, and transmits to all the terminals 10 the notification that the remaining number to reach the set number is “1 (terminal)”. If the transmission request is received next from the terminal 10f, the terminal determination unit 23 transmits the transmission permission to the terminal 10f. The terminal determination unit 23 transmits to all the terminals 10 the notification that the remaining number is “0 (terminal)”. Upon receiving a transmission cancellation request from the terminal 10a, the terminal determination unit 23 transmits to all the terminals 10 the notification that the remaining number is “1 (terminal)”. Note that the terminal determination unit 23 may perform a process similar to the above process in response to the reception request.

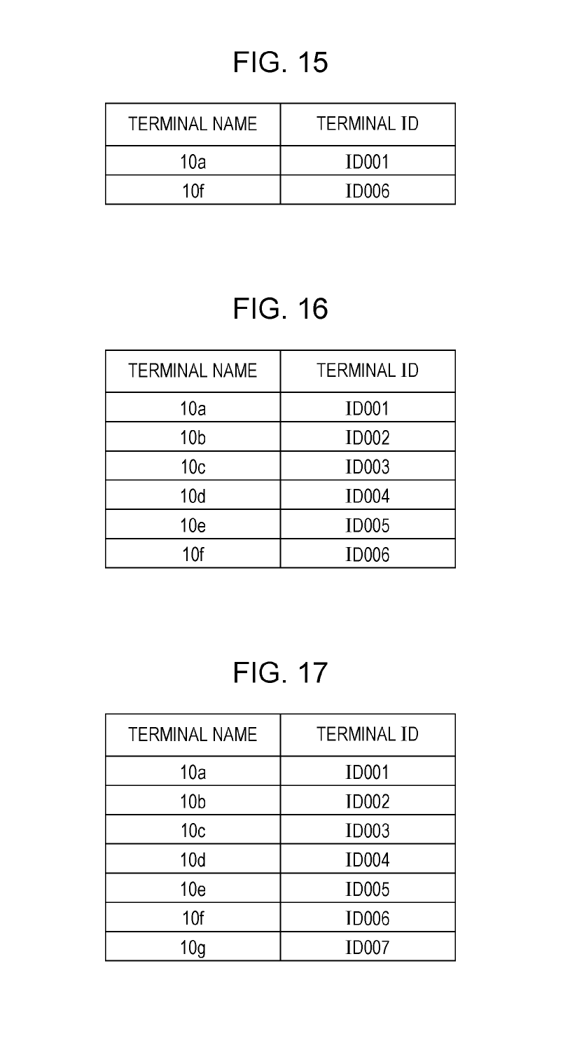

The terminal information generation unit 27 in the server 20 generates transmitting terminal information in response to the transmission request received by the reception processor 21 and the determination results by the terminal determination unit 23. More specifically, if the total number of terminals is equal to or below the set number of terminals, the terminal information generation unit 27 generates a transmitting terminal list listing terminal information of the terminal 10 permitted to perform the audio transmission. For example, if the transmission requests received from the terminals 10a and 10f are permitted, the terminal information generation unit 27 generates the transmitting terminal list listing the terminal information, such as name and identification information (terminal ID, IP address, and the like) of the terminals 10a and 10f. FIG. 15 illustrates an example of the transmitting terminal list. Each time the received transmission request is permitted, or each time the transmission request is canceled, the terminal information generation unit 27 updates the transmitting terminal list. The generated transmitting terminal list is stored on the terminal information DB 31.

The terminal information generation unit 27 generates a receiving terminal list in response to the reception request received by the reception processor 21. More specifically, the terminal information generation unit 27 generates the receiving terminal list listing the terminal information of the terminal 10 permitted the audio. For example, the reception requests received from the terminals 10a through 10f are permitted, the terminal information generation unit 27 generates the receiving terminal list listing the terminal information, such as name and identification information (terminal ID, IP address, and the like) of the terminals 10a through 10f. FIG. 16 illustrates an example of the receiving terminal list. Each time the received reception request is permitted, or each time the reception request is canceled, the terminal information generation unit 27 updates the receiving terminal list. FIG. 17 illustrates an updated receiving terminal list when a new reception request received from the terminal 10g (not illustrated) connected to the network is permitted in the state of FIG. 16. The generated receiving terminal list is stored on the terminal information DB 31.

The terminal information generation unit 27 transmits the receiving terminal list to the terminal 10 that the terminal determination unit 23 permits to transmit the audio. When the receiving terminal list is updated, the terminal information generation unit 27 transmits the updated receiving terminal list to the terminal 10 that is permitted to transmit the audio. For example, if the terminals 10a and 10f are permitted to transmit the audio, the terminal information generation unit 27 transmits the receiving terminal list (see FIG. 16) to the terminals 10a and 10f. When the receiving terminal list is updated, the terminal information generation unit 27 transmits the updated receiving terminal list to the terminals 10a and 10f. In such a case, only an updated (added) receiving terminal list may be transmitted. The terminal information generation unit 27 has a function of a receiving terminal information notification unit.

The determination result acquisition unit 12 (see FIG. 15) in the terminal 10 receives (or acquires) the determination results of the terminal determination unit 23 in the server 20. For example, the determination result acquisition unit 12 in each of the terminals 10a and 10f acquires the permission notification of the audio transmission.

The terminal information acquisition unit 13 (terminal information receiving unit) (see FIG. 12) in the terminal 10 acquires the receiving terminal list from the terminal information generation unit 27 in the server 20. For example, the terminal information acquisition unit 13 in each of the terminals 10a and 10f acquires the receiving terminal list of FIG. 16 from the server 20.

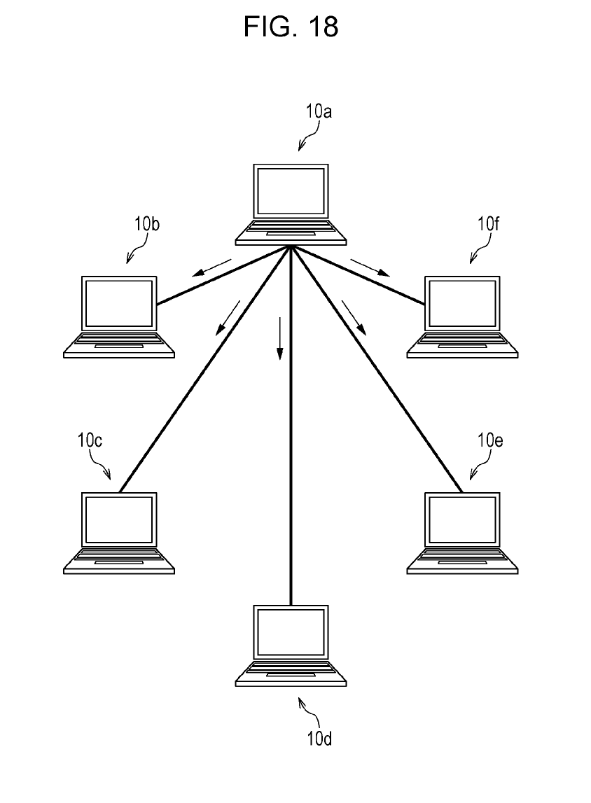

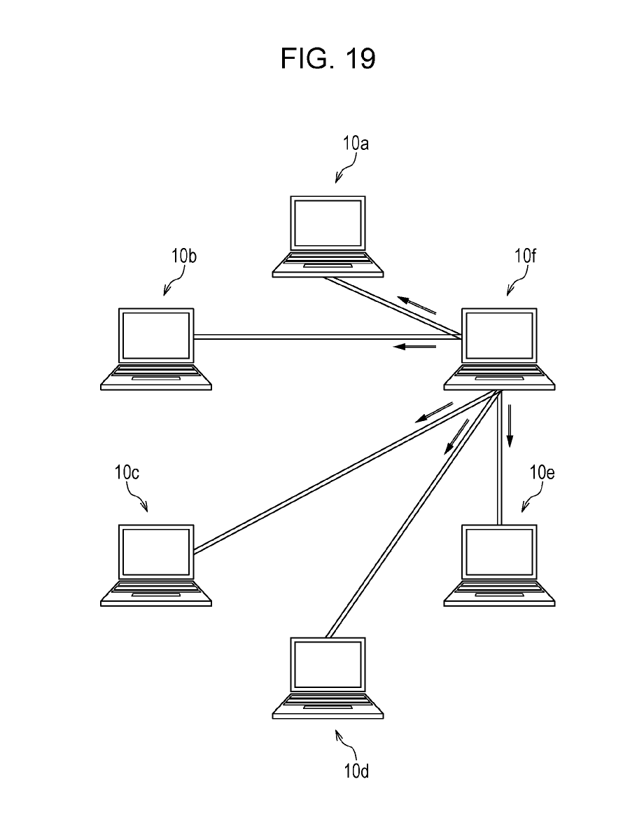

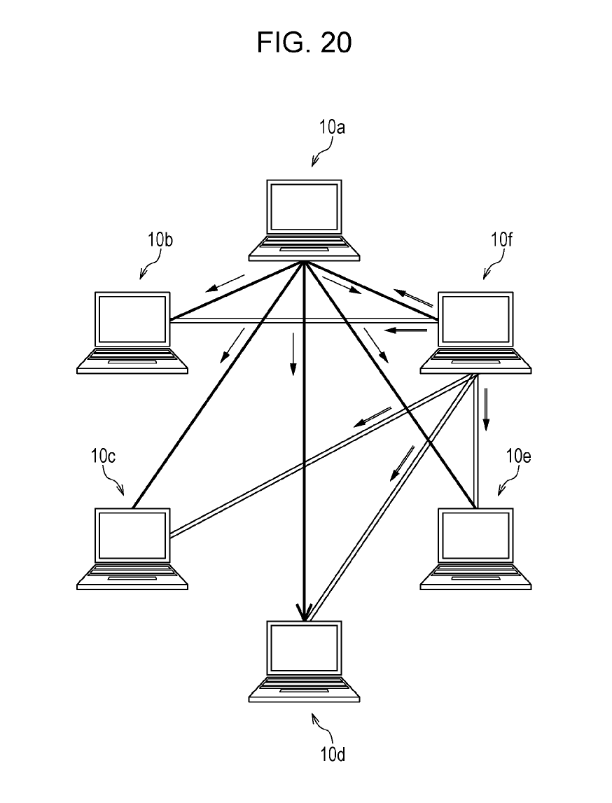

The communication path establishing unit 14 in the terminal 10 (see FIG. 12) establishes a communication path to transmit (exchange) audio data to another terminal 10 in accordance with the receiving terminal list acquired by the terminal information acquisition unit 13. The acquired receiving terminal list is stored on the storage unit 103. The communication path establishing unit 14 in the terminal 10a establishes the communication path between the terminal 10a and each of the terminals 10b, 10c, 10d, 10e, and 10f. FIG. 18 illustrates a network indicating the communication path established between the terminal 10a and each of the terminals 10b, 10c, 10d, 10e, and 10f. Similarly, the communication path establishing unit 14 in the terminal 10f establishes a communication path between the terminal 10f and each of the terminals 10a, 10b, 10c, 10d, and 10e. FIG. 19 illustrates a network indicating the communication path established between the terminal 10f and each of the terminals 10a, 10b, 10c, 10d, and 10e. FIG. 20 illustrates a network that includes all the communication paths established described above. The direction of each arrow represents the transmission direction of the audio data. FIG. 18 through FIG. 20 illustrate a network configuration in which the audio data is transmitted and received without the server 20. The network configuration is not limited to those illustrated herein. The audio data may be transmitted and received via the server 20 serving as a relay.

A terminal transmitting the audio (transmitting terminal) establishes a communication path to a terminal receiving the audio (receiving terminal) in accordance with the IP address and port number of the receiving terminal information. For example, if the user A sets the check box for the “audio transmission” unchecked on the display 106 of the terminal 10a, the communication path establishing unit 14 cancels the established communication path.

If the communication path establishing unit 14 has established the communication paths, the audio transmitting unit 15 in the terminal 10 (see FIG. 12) transmits (distributes) the audio data input to the audio input unit 107 to each terminal 10 via the communication paths. For example, the audio transmitting unit 15 transmits the audio data corresponding to the statement (voice) of the user A input to the audio input unit 107 in the terminal 10a to each of the terminals 10b, 10c, 10d, 10e, and 10f via the communication paths (single solid lines of FIG. 20) and the audio transmitting unit 15 transmits the audio data corresponding to the statement (voice) of the user F input to the audio input unit 107 in the terminal 10f to each of the terminals 10a, 10b, 10c, 10d, and 10e via the communication paths (double solid lines of FIG. 20). In this way, the statements (audio data) of the users A and F are transmitted to the other terminals 10 at the same timing. Note that the audio transmitting unit 15 may stream the audio data or transmit an audio data file. If the transmitting terminal and receiving terminal supports a web browser, an audio stream of the transmitting terminal may be linked to the receiving terminal using web real-time communication (WebRTC).

The display controller 16 (see FIG. 12) in the terminal 10 causes the display 106 to display the display contents acquired by the determination result acquisition unit 12. For example, if the determination result acquisition unit 12 acquires the permission notification of the audio transmission from the server 20, the display controller 16 causes the display 106 to display a message that the audio transmission is permitted. If the determination result acquisition unit 12 acquires the denial notification of the audio transmission from the server 20, the display controller 16 causes the display 106 to display an error message that the audio transmission is denied, and modifies the display 106 so that the selection screen of the “audio transmission” (the check box or the electronic button) is unselectable. For example, an electronic button to select the audio transmission (transmission request) is grayed out (inactivated). In this way, the electronic button may not be selected (pressed) or a message saying that the transmission request is currently not permitted may be displayed on the display 106. The display controller 16 controls the display contents on the display 106 so that the user may not transmit new audio (make a transmission request).

The determination result acquisition unit 42 (see FIG. 13) in the terminal 10 receives (or acquires) the determination results of the terminal determination unit 23 in the server 20. For example, the determination result acquisition unit 42 in each of the terminals 10a through 10f acquires the permission notification of the audio reception from the server 20.

If the determination result acquisition unit 42 acquires the permission notification, the display controller 43 (see FIG. 13) in the terminal 10 causes the display 106 to display a message that the audio reception is permitted. If the determination result acquisition unit 42 acquires the denial notification of the audio reception from the server 20, the display controller 43 causes the display 106 to display an error message indicating the denial of the audio reception and modifies the selection screen of the “audio reception” displayed on the display 106 such that the checkbox or the electronic button is not selected.

The audio receiving unit 44 (see FIG. 13) in the terminal 10 receives the audio data transmitted via the communication path. The audio output unit 108 converts the received audio data into an audio, and outputs the audio. For example, the audio receiving unit 44 in each of the terminals 10b, 10c, 10d, 10e, and 10f receives the audio data corresponding to the statement (audio) of the user A transmitted via the communication paths (the single solid lines in FIG. 20) from the terminal 10a, and the audio output unit 108 outputs the audio. The audio receiving unit 44 in each of the terminals 10a, 10b, 10c, 10d, and 10e receives the audio data corresponding to the statement (audio) of the user F transmitted via the communication paths (the double solid lines in FIG. 20) from the terminal 10f, and the audio output unit 108 outputs the audio. In this way, the user B, user C, user D, and user E of the terminals 10b, 10c, 10d, and 10e hear the statements of the user A and the user F at the same timing.

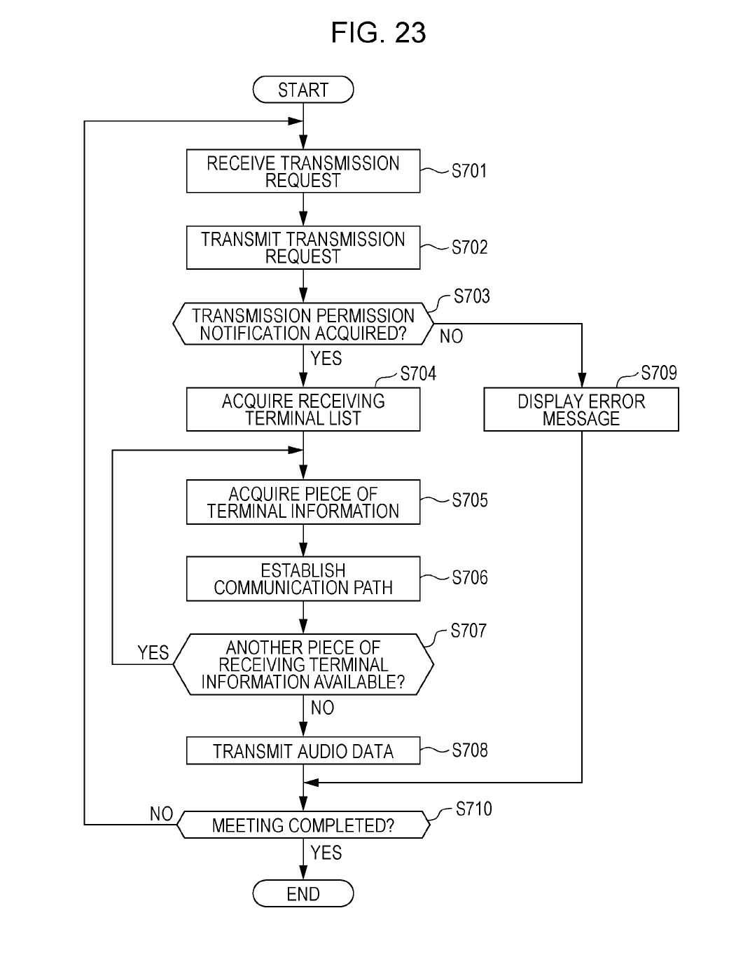

The process flow of the server 20 is described with reference with a flowchart. FIG. 21 illustrates an operational flowchart of the terminal count determination process performed when the server 20 receives the transmission request from the terminal 10 (step S21 of FIG. 14). When a meeting is started, this process is performed when the notification unit 24 (see FIG. 3) in the server 20 notifies multiple terminals 10 connected to the server 20 via the network of a meeting start notice. The same is true of processes of FIG. 22 and FIG. 23.

When the transmission request is transmitted from the terminal 10, the reception processor 21 receives the transmission request (step S501). The terminal determination unit 23 compares the total number of terminals 10 having made the transmission request with the predetermined set number of terminals to determine whether the total number is equal to or above the set number (step S502).

If the total number of terminals is equal to or below the set number of terminals, the terminal determination unit 23 transmits to the terminal 10 the permission notification of the audio transmission and the terminal information generation unit 27 generates the transmitting terminal list (see FIG. 15) (step S503). The terminal information generation unit 27 transmits to the terminal 10 registered in the transmitting terminal list the receiving terminal list listing information of the terminals having made the reception request (step S504).

If the total number is above the set number in step S502, the terminal determination unit 23 transmits the denial notification of the audio transmission to the terminal 10 having made the transmission request (step S505). Operations in steps S501 through S505 are repeated until the meeting ends (step S506).

FIG. 22 illustrates an operational flowchart of a receiving terminal list generation process performed when the server 20 receives the reception request from the terminal 10 (step S22 of FIG. 14).

When a reception request is transmitted from the terminal 10, the reception processor 21 receives the reception request (step S601). The terminal information generation unit 27 generates or updates the receiving terminal list (see FIG. 16) (step S602). The terminal information generation unit 27 transmits the permission notification of the audio reception to the terminal 10 registered in the receiving terminal list (step S603). The audio reception is permitted herein to all the reception requests received by the reception processor 21. Alternatively, the terminal determination unit 23 may permit the audio reception only if the total number is equal to or below the set number, and the denial notification of the audio reception may be transmitted to the terminal 10 if the audio reception is denied. The terminal information generation unit 27 then acquires the transmitting terminal list and transmits the receiving terminal list to each of the terminals 10 registered in the transmitting terminal list (step S604). If the receiving terminal list is modified (updated), only the updated (added) receiving terminal list may be transmitted. Operations in steps S601 through S604 may be repeated until the meeting ends (step S605).

FIG. 23 illustrates an operational flowchart of a process performed when a user makes a transmission request on the terminal 10.

During the meeting, the terminal 10 receives the transmission request from the user (step S701). The transmission request transmitting unit 11 transmits the received transmission request to the server 20 (step S702). Upon receiving the transmission request, the server 20 performs the operations in steps S501 through S505 of FIG. 21.

The determination result acquisition unit 12 in the terminal 10 acquires the transmission permission notification or the transmission denial notification from the server 20 (step S703). If the transmission permission notification is acquired, the terminal information acquisition unit 13 acquires the receiving terminal list from the server 20 (step S704).

The communication path establishing unit 14 acquires the terminal information (terminal ID) of any one terminal 10 in the receiving terminal list (step S705). The communication path establishing unit 14 establishes the communication path to transmit the audio data to the terminal 10 corresponding to the acquired terminal information (step S706). The communication path establishing unit 14 establishes the communication paths for all the terminals 10 registered in the receiving terminal list (step S707).

The audio transmitting unit 15 transmits the audio data to each of the terminals 10 through the established communication paths.

If the determination result acquisition unit 12 receives the transmission denial notification from the server 20 in step S703, the display controller 16 in the terminal 10 causes the display 106 to display an error message (step S709). The operations in steps S701 through S709 are repeated until the meeting ends (step S710).

The electronic conference system 200 of the second exemplary embodiment sets an upper limit to the number of transmitting terminals granted the right to speak (to transmit an audio), and dynamically changes the terminals granted transmission in response to an instruction from each user. The electronic conference system 200 thus establishes the communication path between the terminal granted transmission and each of the other terminals. Even if the number of terminals connected via the network increases, higher quality data communications are ensured among the terminals. If each user desires to transmit a statement (audio) or receives an audio, the user may select the operation as he or she intends. The communication paths are dynamically established and changed between the terminals in response to the users' own intentions.

The electronic conference system 200 controls audio data communications regardless of the shared state (synchronous or asynchronous state) of the materials (display contents). For example, a network of communication paths to transmit and receive audio data may now be constructed as illustrated in FIG. 20, and the user A of the terminal 10a may be a presenter who operates the display contents. The user A may make a statement (explaining the display contents) while operating the terminal 10a. In this way, the users B through F of the terminals 10b, 10c, 10d, 10e, and 10f view their respective display screens reflecting the contents of the operation performed on the terminal 10a while listening to the comment (voice) of the user A output from the audio output unit 108 in each of their respective terminals.

If the presenter is changed (the operation right is transferred) from the user A to the user F during the meeting, the user F makes a statement (about new display contents) while operating the terminal 10f for the new display contents. Since the user F has the right to speak in the network of FIG. 20, constructing a new communication path for the audio data is not needed even if the operation right is transferred. For this reason, audio communications are seamlessly performed in a manner free from an interruption and a delay in the audio output. The meeting thus proceeds efficiently.

If the presenter is changed from the user A to the user B during the meeting, the user B then operates the terminal 10b for new display contents. If the user B requests the audio transmission, new communication paths are constructed in a process as described above. If the user B does not request the audio transmission, the network of FIG. 20 is maintained. This configuration is useful in applications where a user operating a material is different from a user making a comment about the material.

The shared state (synchronous state or asynchronous state) of the materials (display contents) and the shared state of audio data are separately controlled in the electronic conference system 200. The communication path is reconstructed with one terminal is dynamically switched to another terminal to transmit the audio while the materials (display contents) are maintained in the share state. One terminal is switched to another terminal, granted the operation right, while the communication path for the audio is maintained. In this way, the audio data is virtually exchanged among a large number of terminals while the materials (display contents) are shared thereamong. More specifically, the contents of the operation by the presenter on the material are synchronized while the audio is bilaterally exchanged among a large number of terminals.

The electronic conference system 200 to transmit and receive the audio is not limited to the configuration described above. The electronic conference system 200 may have a variety of configurations. The following discussion of modifications of the electronic conference system 200 focuses on differences from the configuration described above. In the following discussion of the modifications of the electronic conference system 200, elements similar in function to those of the electronic conference system 200 are not described.

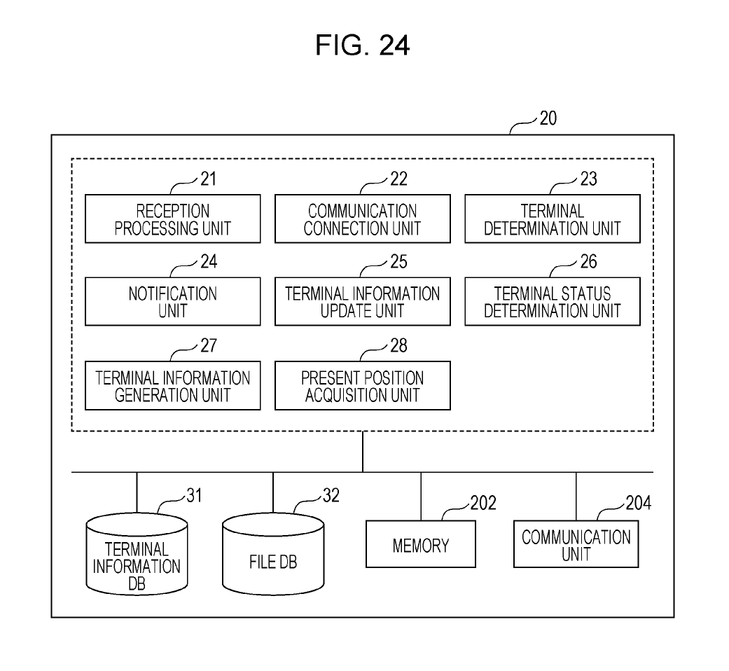

In a first modification of the electronic conference system 200, the server 20 may further include a present position acquisition unit 28 to acquire the present position of the terminal 10. FIG. 24 is a functional block diagram illustrating a specific configuration of the server 20 of the first modification.

The present position acquisition unit 28 receives values detected by a position detector (not illustrated), such as global positioning system (GPS) included in the terminal 10, and acquires the present position (such as an address) of each terminal 10. The present position acquisition unit 28 may preset the position information and an IP address, and a subnet of the network in association with each other, and may acquire the present position of the terminal 10 by acquiring the IP address of the terminal 10.

The terminal determination unit 23 determines whether to permit the terminal 10 having transmitted the reception request to receive the audio, based on the reception request received by the reception processor 21 and the present position of each terminal 10 acquired by the present position acquisition unit 28.

The terminal information generation unit 27 generates the receiving terminal information based on the reception request received by the reception processor 21 and the determination results of the terminal determination unit 23. More specifically, the terminal information generation unit 27 generates the receiving terminal list listing the information of the terminals 10 permitted by the terminal determination unit 23, from among the terminals 10 having made the reception request. The terminal information generation unit 27 transmits the receiving terminal list to the terminal 10 permitted to transmit the audio by the terminal determination unit 23.

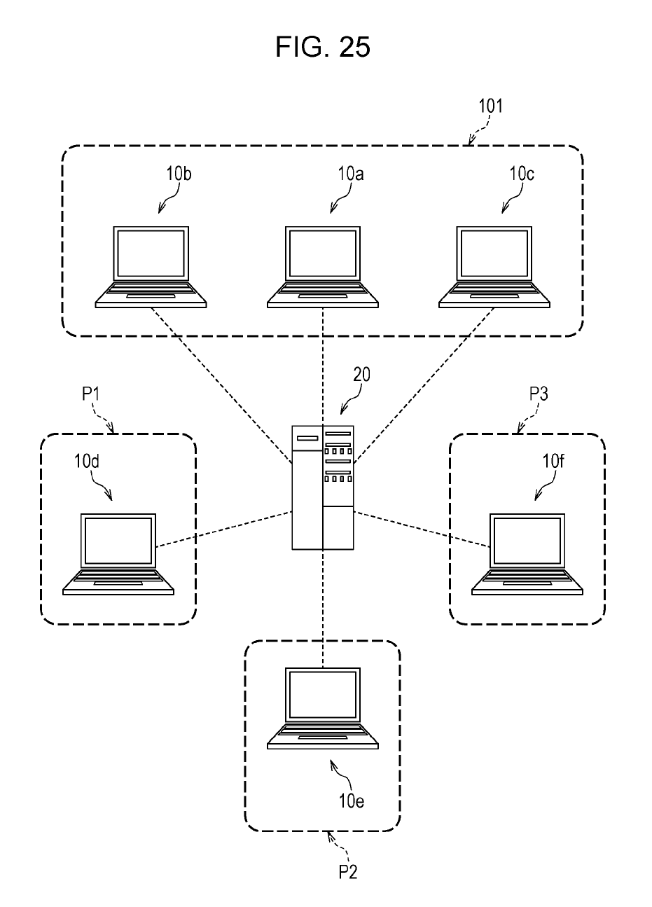

This process is specifically described. FIG. 25 illustrates a network. In the network, the terminals 10a, 10b, and 10c are arranged in the same meeting room 101, the terminal 10d at a remote location P1 from the meeting room 101, the terminal 10e at a remote location P2 from the meeting room 101, and the terminal 10f at a remote location P3 from the meeting room 101.

In the network of FIG. 25, the terminals 10a and 10f may now transmit the transmission requests, and the terminals 10a through 10f may transmit the reception requests. The terminals 10a and 10f are permitted to transmit the audio because the total number of the transmission request (2) is equal to or below the set number (3).

The present position acquisition unit 28 acquires the present positions of the terminals 10a through 10f. More specifically, the present position acquisition unit 28 acquires the “meeting room 101” as the present position of the terminals 10a, 10b, and 10c, the “remote location P1” as the present position of the terminal 10d, the “remote location P2” as the present position of the terminal 10e, and the “remote location P3” as the present position of the terminal 10f.

The terminal determination unit 23 determines whether the present position of each terminal 10 remains unchanged or at a place within a predetermined area (predetermined place). If multiple terminals 10 are present at the predetermined place, the terminal determination unit 23 permits one of the multiple terminals 10 to receive the audio, and denies the audio reception to the other terminals 10. In the network of FIG. 25, the terminal determination unit 23 permits the terminal 10a from among the terminals 10a, 10b, and 10c present at the predetermined place (meeting room 101) to receive the audio, but denies the audio reception to the terminals 10b and 10C. The terminal determination unit 23 transmits the determination results (the permission notification or the denial notification) to the terminals having transmitted the reception request.

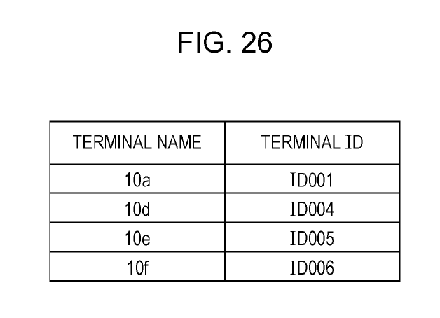

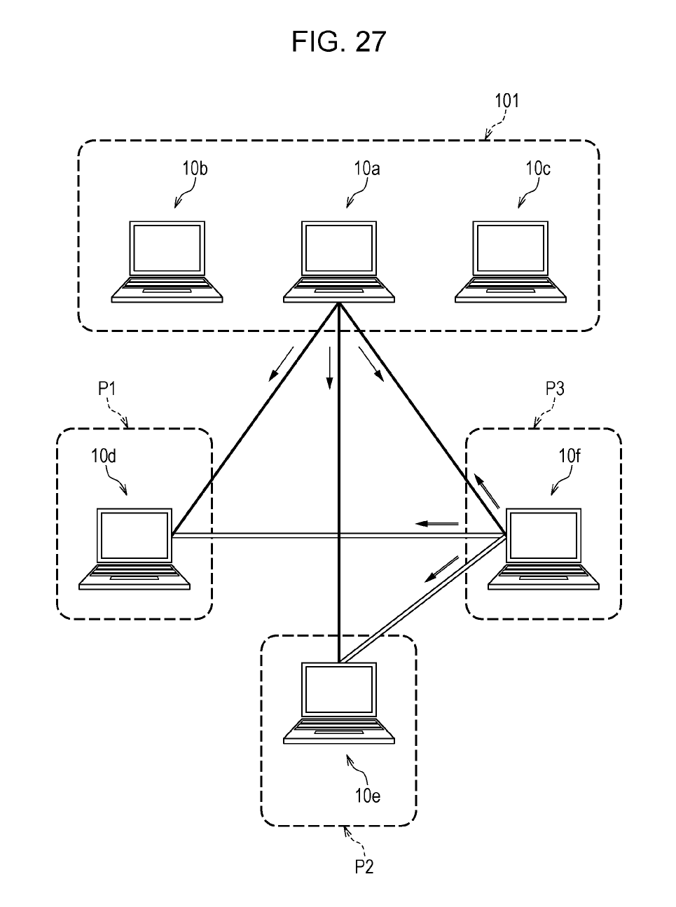

The terminal information generation unit 27 generates the receiving terminal list of FIG. 26 in response to the determination results, and transmits the receiving terminal list to the terminals 10a and 10f. The terminals 10a and 10f establish the communication paths in accordance with the acquired receiving terminal list. FIG. 27 illustrates an example of a network configuration of a communication paths established in the electronic conference system 200 of the first modification.

Multiple terminals 10 located at a predetermined place may make the transmission request. In such a case, the terminal determination unit 23 permits one terminal 10 from among the terminals 10 having made the transmission request to transmit the audio, and denies the other terminals 10 the audio transmission. For example, the terminals 10a, 10b, and 10c in the meeting room 101 may now make the transmission request. The terminal determination unit 23 then permits the terminal 10a to transmit the audio, but denies the terminals 10b and 10c the audio transmission. The terminal information generation unit 27 transmits the receiving terminal list to the terminal 10a permitted to transmit the audio, and the terminal 10a establishes the communication paths in accordance with the acquired receiving terminal list.

During the meeting held in the network configuration described above, multiple users (for example, users B and C) of multiple terminals 10 in the same meeting room can hear directly the comment made by one of the users (for example, the user A). One of the terminals 10 (for example, the terminal 10a) may receive a comment made by another user (the user D, E, or F) at the remote place and output the comment. The multiple users may thus hear the comment. The electronic conference system 200 of the first modification works with a reduced number of communication paths.

In a second modification of the electronic conference system 200, the set number of terminals may be dynamically changed. More specifically, the set number of terminals may be changed in accordance with the number of all terminals 10 connected via the communication network 30. As the number of terminals 10 is increased, the set number may be decreased. The second modification is useful in an electronic conference, such as a seminar, in which the number of speakers (presenters) is limited. The set number of terminals may be calculated and set in accordance with a percentage basis to all the terminals 10 connected via the communication network 30. The set number may be set in accordance with the number of terminals 10 having made the reception request.

In the electronic conference system 200 of a third modification, if a time of period throughout which any audio data is untransmitted from the terminal 10 permitted to transmit the audio reaches a predetermined period of time, the communication path establishing unit 14 may cancel the communication path to the terminal 10. For example, if the user A permitted to transmit the audio remains silent for a predetermined period of time, the communication path establishing unit 14 force-cancels the communication path established to the terminal 10a of the user A. In the third modification, a user who operates a transmitting terminal may be photographed using a camera, a photographed image may then be analyzed to determine whether the user speaks or to measure a period of time throughout which the user remains silent. The camera may or may not be external to the terminal 10. For example, the camera may be installed in the meeting room.

In the exemplary embodiment, the display controller 16 in the terminal 10 causes the display 106 to display the error message as illustrated in FIG. 23 if the transmission denial notification is received. The present invention is not limited to this method performed if the audio transmission is denied.

In the electronic conference system 200 of a fourth modification, for example, the terminal 10 may control the check box not to accept a check mark if the total number of transmitting terminals reaches the set number at the moment the terminal 10 is connected to the server 20. The terminal 10 may control the check box by acquiring information from the server 20 in accordance with an increase or decrease in the total number of transmitting terminals. The number of transmitting terminals may be acquired by polling the server 20. Alternatively, the server 20 may notify each terminal 10 of the total number of transmitting terminals with WebSocket set to be in a ready state.

The electronic conference system 200 may be configured as described below.

Even if a large number of terminals is connected to each other in the electronic conference system 200, the number of persons (speaker terminals) that speak concurrently at a given moment is limited. The number of persons (the number of transmitting terminals) that are permitted to speak concurrently is limited while the establishment of the communication paths is dynamically modified with the transmitting terminals switched. In this way, the audio data may be virtually exchanged among a large number of terminals.

The electronic conference system 200 allows each terminal 10 to select the audio transmission and the audio reception, and notifies the server 20 of any change in the audio transmission and audio reception on each terminal 10.

The server 20 notifies each terminal 10 having selected the audio transmission of a list of terminals having selected the audio reception. The server 20 is free from notifying each terminal of information about a terminal unchanged in state. A transmitting terminal having received the notification calls only a newly registered receiving terminal to receive stream information of the transmitting terminal (transmits a connection request).

In the electronic conference system 200, the server 20 manages the total number of terminals that may concurrently transmit. If the total number reaches an upper limit (set number), the server 20 denies another terminal the transmission request.

In the electronic conference system 200, the transmitting terminals include a standard transmitting terminal and a temporary transmitting terminal. The temporary transmitting terminal is permitted to transmit for a predetermined period of time, and the audio transmission thereof is canceled after the elapse of the predetermined period of time (the check box of the transmission request is set to be unchecked). In another example, the temporary transmitting terminal may be enabled to transmit only while the user keeps an audio transmission button pressed. In yet another example, the transmission request may be canceled on the temporary transmitting terminal if a silent state continues for a predetermined period of time.

In the electronic conference system 200, a user who wishes to speak may make the transmission request and give a user specified in a particular terminal (master terminal) the right to speak (permits the particular terminal to be a transmitting terminal).

In the electronic conference system 200, if a given terminal is granted the operation right, the terminal may be automatically permitted to transmit the audio. More specifically, the electronic conference system 200 is configured in a manner such that the terminal granted the operation right automatically becomes a terminal transmitting the audio.

The electronic conference systems of the exemplary embodiment and modifications described above have been described for exemplary purposes, and may be combined in use.

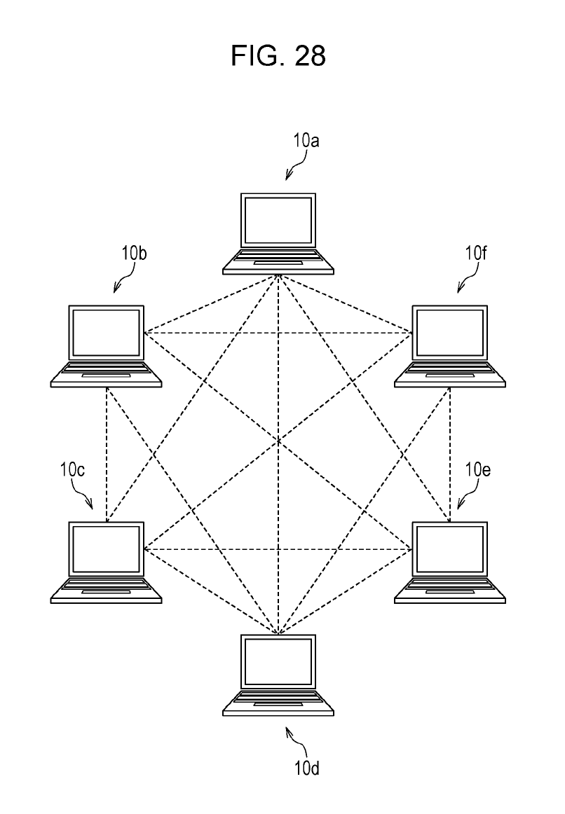

The network of each electronic conference system is not limited to the network of FIG. 4. The network may not necessarily have to include the server 20 (as illustrated in FIG. 28). The configuration of FIG. 28 may be implemented by downloading the program corresponding to each element included in each of the electronic conference systems onto the terminals 10a through 10f. More specifically, each electronic conference system is implemented by the CPU in each terminal when the CPU executes the program stored on the memory in each of the terminals 10a through 10f. The program to be downloaded may be constructed in JavaScript (registered trademark). The terminal 10 having the program downloaded to and recorded thereon may function as an information processing apparatus. A computer on which the program is downloaded may be the terminal 10 or the server 20.

The electronic conference system 200 is not limited to the transmission or reception of the audio data. More specifically, the electronic conference system 200 is applicable to transmitting and receiving media data including the audio data and video data (moving image data). The electronic conference systems are applicable to a variety of electronic conferences including a television conference and a telephone conference. In the television conference, a video captured by a camera mounted on each terminal is bilaterally communicated between terminals via the communication paths. Each of the electronic conference systems is also applicable to a television conference in which participants are remotely separated from each other.

The electronic conference systems have been described as an example of the information processing system. The information processing system is not limited to the electronic conference system, and includes a variety of systems that share media data across the networked terminals.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for displaying parts of display screens in synchronization across a plurality of terminals connected via a network, the process comprising:
receiving connection requests from the terminals;
granting to one of the terminals having transmitted the connection requests an operation right to operate on materials that are displayed in synchronization; and
notifying the terminals, other than the terminal that has been granted the operation right from among the terminals having transmitted the connection requests, of material information of the materials displayed on the terminal and operation information indicating contents of an operation performed on the materials.

2. The non-transitory computer readable medium according to claim 1, wherein the process further comprises:
receiving a transmission request of media data including at least one piece of audio data and video data from at least one of the terminals;
receiving a reception request of the media data from at least one of the terminals; and
notifying the terminal having made the transmission request of information related to the terminal having made the reception request if a total number of terminals having made the transmission requests is equal to or below a predetermined set number of terminals.

3. The non-transitory computer readable medium according to claim 1, wherein with no terminal granted the operation right, the granting asks the terminals having transmitted the connection request whether the terminals desire to obtain the operation right, and grants the operation right to a terminal that desires to obtain the operation right; and
wherein the notifying instructs a terminal not desiring to obtain the operation right to display a standby screen.

4. The non-transitory computer readable medium according to claim 1, wherein the process further comprises receiving a transfer request of the operation right from one of the terminals used by a plurality of participants; and
transmitting to the terminal granted the operation right a query as to whether to permit the transfer of the operation right,
wherein the granting transfers the operation right to the terminal that has transmitted the transfer request if a reply instructing the transfer request to be permitted is received from the terminal granted the operation right.

5. The non-transitory computer readable medium according to claim 4, wherein the granting determines that the terminal granted the operation right has permitted the transfer request and transfers the operation right to the terminal having transmitted the transfer request if a predetermined set time has elapsed since the transmission of the query.

6. The non-transitory computer readable medium according to claim 1, wherein the notifying notifies the terminals used by a plurality of participants that there is no terminal that is granted the operation right if the terminal granted the operation right is cut off from the network during a meeting.

7. The non-transitory computer readable medium according to claim 6, wherein the notifying transmits to the terminals used by the participants a query as to whether each of the terminals desires to obtain the operation right, and
wherein the granting transfers the operation right to a terminal that desires to obtain the operation right.

8. The non-transitory computer readable medium according to claim 1, wherein if the operation right is transferred to another terminal, the terminal having the operation right transferred thereto transmits a selection request of a new material to be shared in a meeting,
wherein the notifying notifies the terminals used by the other participants of the operation information related to a material selected by the terminal having the operation right transferred thereto.

9. The non-transitory computer readable medium according to claim 1, wherein the notifying notifies a terminal used by a participant of a standby message if no terminal is granted the operation right.

10. The non-transitory computer readable medium according to claim 2, wherein the process further comprises establishing a communication path to transmit the media data between the terminal having made the transmission request and at least one of the terminals having made the reception request if the total number of terminals having made the transmission request is equal to or below the predetermined set number of terminals.

11. The non-transitory computer readable medium according to claim 10, wherein the establishing leaves the communication path unmodified if the terminals having made transmission request include the terminal granted the operation right and the terminal having the operation right transferred thereto with the communication path established between the terminals having made the transmission request and the terminals having made the reception request.

12. The non-transitory computer readable medium according to claim 2, wherein if the terminal is granted the operation right, the terminal is permitted to transmit the media data thereof.

13. The non-transitory computer readable medium according to claim 10, wherein the process further comprises acquiring a present position of each of the terminals, and
wherein if a plurality of the terminals having made the reception request is present within a predetermined area, the establishing establishes the communication path to one of the terminals.

14. The non-transitory computer readable medium according to claim 10, wherein if a new transmission request has been received from a terminal with the total number of terminals having made the transmission request having reached the predetermined set number, the establishing denies establishing the communication path to the terminal having made the new transmission request.

15. The non-transitory computer readable medium according to claim 10, wherein the establishing cancels the communication path to a terminal having made the transmission request if a duration of time throughout which the media data remains untransmitted from the terminal reaches a predetermined period of time with the communication path established.

16. The non-transitory computer readable medium according to claim 10, wherein the process further comprises controlling display contents on a display screen of the terminal,
wherein the controlling causes the display screen to display the display contents in a manner such that a user is unable to select a new transmission request if the total number of terminals having made the transmission request has reached the set number, and modifies the display contents on the display screen in a manner such that the user is enabled to select the new transmission request if the total number of terminals having made the transmission request is less than the set number.

17. An information processing apparatus displaying parts of display screens in synchronization across a plurality of terminals connected via a network, the information processing apparatus comprising:
a reception unit that receives connection requests from the terminals;
a right granting unit that grants to one of the terminals having transmitted the connection requests an operation right to operate on materials that are displayed in synchronization; and
a notification unit that notifies the terminals, other than the terminal that has been granted the operation right from among the terminals having transmitted the connection requests, of material information of the materials displayed on the terminal and operation information indicating contents of an operation performed on the materials.

18. The information processing apparatus according to claim 17 further comprising:
a transmission request receiving unit that receives a transmission request of media data including at least one piece of audio data and video data from at least one of the terminals;
a reception request receiving unit that receives a reception request of the media data from at least one of the terminals; and
a receiving terminal information notification unit that notifies the terminal having made the transmission request of information related to the terminal having made the reception request if a total number of terminals having made the transmission requests is equal to or below a predetermined set number of terminals.

19. An information processing system displaying parts of display screens in synchronization across a plurality of terminals connected via a network, and causing the terminals to transmit and receive media data including at least a piece of audio data and video data, the information processing system comprising:
a reception unit that receives connection requests from the terminals;
a right granting unit that grants to one of the terminals having transmitted the connection requests an operation right to operate on materials that are displayed in synchronization;
a notification unit that notifies the terminals, other than the terminal that has been granted the operation right from among the terminals having transmitted the connection requests, of material information of the materials displayed on the terminal and operation information indicating contents of an operation performed on the materials;
a transmission request receiving unit that receives a transmission request of media data including at least one piece of audio data and video data from at least one of the terminals;
a reception request receiving unit that receives a reception request of the media data from at least one of the terminals; and
a receiving terminal information notification unit that notifies the terminal having made the transmission request of information related to the terminal having made the reception request if a total number of terminals having made the transmission requests is equal to or below a predetermined set number of terminals.

20. An information processing method for displaying parts of display screens in synchronization across a plurality of terminals connected via a network, the information processing method comprising
receiving connection requests from the terminals;
granting to one of the terminals having transmitted the connection requests an operation right to operate on materials that are displayed in synchronization; and
notifying the terminals, other than the terminal that has been granted the operation right from among the terminals having transmitted the connection requests, of material information of the materials displayed on the terminal and operation information indicating contents of an operation performed on the materials.
